(19) United States
(12) Patent Application Publication
(10) Pub. No.: US 2024/0120494 A1
(43) Pub. Date: Apr. 11, 2024

(54) ELECTRODES FOR ENERGY STORAGE DEVICES

(71) Applicant: FastCAP Systems Corporation, Wakefield, MA (US)

(72) Inventors: Nicolo Brambilla, Brookline, MA (US); Wanjun Ben Cao, Boston, MA (US); Ji Chen, Natick, MA (US); Thomas M. Yu, Brookline, MA (US); Neal Dawson-Elli, Boston, MA (US)

(21) Appl. No.: 18/481,651

(22) Filed: Oct. 5, 2023

Related U.S. Application Data
(60) Provisional application No. 63/413,435, filed on Oct. 5, 2022.

(51) Int. Cl. H01M 4/62; H01M 4/131; H01M 4/133; H01M 4/134; H01M 4/36; H01M 4/48; H01M 4/505; H01M 4/525; H01M 4/587; H01M 4/66; H01M 10/0567; H01M 10/0568; H01M 10/0569

(52) U.S. Cl. CPC H01M 4/625; H01M 4/131; H01M 4/133; H01M 4/134; H01M 4/364; H01M 4/483; H01M 4/505; H01M 4/525; H01M 4/587; H01M 4/622; H01M 4/661; H01M 10/0567; H01M 10/0568; H01M 10/0569; H01M 2004/028

(57) ABSTRACT

Disclosed herein is an apparatus comprising an electrode active layer comprising a network of high aspect ratio carbon elements defining void spaces within the network; a plurality of electrode active material particles disposed in the void spaces within the network and enmeshed in the network; and a surface treatment on the surface of the high aspect ratio carbon elements which promotes adhesion between the high aspect ratio carbon elements and the active material particles.

### CROSS-REFERENCE TO RELATED APPLICATIONS

This application claims priority to/from and the benefit of U.S. Provisional Application No. 63/413,435 filed on Oct. 5, 2022, which is incorporated herein by reference in its entirety.

### BACKGROUND

Lithium batteries are used in many products including medical devices, electric cars, airplanes, and consumer products such as laptop computers, cell phones, and cameras. Due to their high energy densities, high operating voltages, and low-self discharges, lithium-ion batteries have overtaken the secondary battery market and continue to find new uses in products and developing industries.

Generally, lithium-ion batteries (“LIBs” or “LiBs”) comprise an anode, a cathode, and an electrolyte material such as an organic solvent containing a lithium salt. More specifically, the anode and cathode (collectively, “electrodes”) are formed by mixing either an anode active material or a cathode active material with a binder and a solvent to form a paste or slurry which is then coated and dried on a current collector, such as aluminum or copper, to form a film on the current collector. The anodes and cathodes are then layered or coiled prior to being housed in a pressurized casing containing an electrolyte material, which all together form a lithium-ion battery.

In conventional electrodes binder is used with sufficient adhesive and chemical properties such that the film coated on the current collector will maintain contact with the current collector even when manipulated to fit into the pressurized battery casing. Since the film contains the electrode active material, there will likely be significant interference with the electrochemical properties of the battery if the film does not maintain sufficient contact with the current collector. Further, it has been important to select a binder that is mechanically compatible with the electrode active material(s) such that it is capable of withstanding the degree of expansion and contraction of the electrode active material(s) during charging and discharging of the battery.

Accordingly, binders such as cellulosic binder or cross-linked polymeric binders have been used to provide good mechanical properties. However, such binder materials have disadvantageous effects. For example, the bulk of the binder fills volume in the electrode active layer which otherwise could be used to increase the mass loading of active material and decrease the electrical conductivity of the electrode. Moreover, binders tend to react electrochemically with the electrolyte used in the cell (especially in high voltage, high current, and/or high temperature applications), resulting in degradation of the performance of the cell.

### SUMMARY

The applicants have realized that an electrode may be constructed to exhibit excellent mechanical stability without the need for bulk polymer binders. In one aspect, the present disclosure describes embodiments of an electrode active layer that includes a network of high aspect ratio carbon elements (e.g., carbon nanotubes, carbon nanotube bundles, graphene flakes, or the like) that provides a highly electrically conductive scaffold that entangles or enmeshes the active material, thereby supporting the layer. As detailed below, a surface treatment can be applied to the high aspect ratio carbon elements to promote adhesion to the active material and any underlying electrode layers (e.g., a current collector layer), thereby improving the overall cohesion and mechanical stability of the active layer. This surface treatment forms only a thin (in some cases even monomolecular) layer on the network, leaving large void spaces that are free of any bulk binder material and so may instead be filled with active material. The resulting active layer may be formed with excellent mechanical stability even at large thickness and high active material mass loading.

In another aspect, the present disclosure describes a method including dispersing high aspect ratio carbon elements and a surface treatment material in a solvent to form an initial slurry, wherein said dispersion step results in the formation of a surface treatment on the high aspect ratio carbon; mixing active materials into the first slurry to form a final slurry; coating the final slurry onto a substrate; and drying the final slurry to form an electrode active layer.

Various embodiments may include any of the features or elements described herein, individually or in any suitable combination.

### BRIEF DESCRIPTION OF THE DRAWINGS

FIG. 1 is a schematic of an electrode featuring an active material layer.

FIG. 2 is a detailed illustration of an embodiment of an active material layer.

FIG. 3 is an illustration of another embodiment of an active material layer.

FIG. 4 is an electron micrograph of an active material of the type described herein.

FIG. 5 is a schematic of an energy storage cell.

FIG. 6 is a flow chart illustrating a method of making the electrode of FIG. 1.

FIG. 7 shows a schematic of a pouch cell battery.

FIG. 8 shows a summary of functional parameters for a pouch cell battery for EV applications.

FIG. 9 shows a summary of functional parameters for a pouch cell battery.

FIG. 10 shows the results of a comparative performance evaluation of a pouch cell battery featuring a binder-free cathode (upper plot) and a pouch cell battery featuring a binder-based cathode (lower plot).

FIG. 11 shows the results of a comparative performance evaluation of a pouch cell battery featuring a binder-free cathode (upper trace) and a pouch cell battery featuring a binder-based cathode (lower trace).

FIG. 12 is a schematic of a half-cell lithium battery apparatus.

FIG. 13 is a plot showing potential (referenced to the Li/Li+ potential) vs specific capacity for binder-free cathode half cell (solid traces) and reference binder-based cathode half cell (dashed traces) at various current densities.

FIG. 14 is a plot showing potential (referenced to the Li/Li+ potential) vs volumetric capacity for binder-free cathode half cell (solid traces) and reference binder-based cathode half cell (dashed traces) at various current densities.

FIG. 15 shows a plot of volumetric capacity vs current density for binder-free cathode half cells (upper trace) and reference binder-based cathode half cell (lower trace).

FIG. 16 shows a Nyquist plot resulting from electrochemical impedance spectroscopy for several binder-free cathode half cells (square, circle and triangle labeled traces) and a reference binder-based cathode half cell. The binder-free cathode half cells exhibit significantly better performance than the reference cell.

FIG. 17 shows the discharge capacity (Ah), and FIG. 18 shows the discharge energy (Wh), for C/10 and C/3 cycles 1 and 2 at 25° C. for a battery cell containing an NCM91 cathode and a silicon-dominant anode.

FIG. 19 shows initial C/10 and C/3 charge/discharge curves at 25° C. for the NCM91 cathode/silicon-dominant anode battery cell.

FIG. 20 shows various discharge C-rate curves at 25° C. for the NCM91 cathode/silicon-dominant anode battery cell.

FIGS. 21A and B show the results of a discharge C-rate cycling test at 25° C. for the NCM91 cathode/silicon-dominant anode battery cell.

FIGS. 22A and B show the results of a charge C-rate cycling test at 25° C. for the NCM91 cathode/silicon-dominant anode battery cell.

FIG. 23 shows various charge C-rate curves at 25° C. for the NCM91 cathode/silicon-dominant anode battery cell.

FIG. 24 shows that, under a 3.5 C-rate fast charge at 25° C., 80% state of charge (SOC) can be achieved in about 15 min of charging of the NCM91 cathode/silicon-dominant anode battery cell.

FIG. 25 shows that, under C/3 cycling in the range of 4.2-2.8 V (100% SOC-5% SOC) at 25° C., the NCM91 cathode/silicon-dominant anode battery cell achieves 400 cycles with about 91% discharge capacity retention.

FIG. 26 shows that, under 100% fast charging via 3.5 C/1 C cycling in the range of 4.2-2.8 V (100% SOC-5% SOC) at 25° C., the NCM91 cathode/silicon-dominant anode battery cell achieves 400 cycles with about 86% discharge capacity retention

FIG. 27 shows the direct current internal resistance (DCIR) over a range of state of charge (SOC) at 25° C. for the NCM91 cathode/silicon-dominant anode battery cell.

FIG. 28A shows dimensions of the NCM91 cathode/silicon-dominant anode battery cell in the form of a pouch cell, and FIG. 28B shows the outside of the pouch cell.

FIG. 29 shows dimensions of a battery cell comprising a nickel-rich NMC cathode and a graphite-dominant anode in the form of a pouch cell.

### DETAILED DESCRIPTION

### Definitions and General Teachings

Unless defined otherwise or clearly indicated otherwise by their use herein, all technical and scientific terms used herein have the same meaning as commonly understood by those of ordinary skill in the art to which this application belongs.

When introducing elements of the present invention or the embodiment(s) thereof, the articles “a”, “an” and “the” are intended to mean that there are one or more of the elements. Similarly, the term “another”, when used to introduce an element, is intended to mean one or more elements. The terms “comprising”, “containing”, “including” and “having” are intended to be inclusive such that there may be one or more other elements in addition to the recited element(s). As used herein, the term “exemplary” is not intended to imply a superlative or preferred example. Rather, the term “exemplary” refers to an illustrative embodiment that is one of many possible embodiments.

The terms “or/and” and “and/or” mean “either . . . or . . . , or both . . . and . . . ” when referring to two elements, and mean “either . . . , . . . or . . . , or any combination or all thereof” when referring to three or more elements. As an example, the phrase “A or/and B” means “either A or B, or both A and B”, and the phrase “A, B or/and C” means “either A, B or C, or any combination or all thereof”.

The term “about” or “approximately” means an acceptable error for a particular value as determined by one of ordinary skill in the art, which depends in part on how the value is measured or determined. In certain embodiments, the term “about” or “approximately” means within one standard deviation. In some embodiments, when no particular margin of error (e.g., a standard deviation to a mean value given in a chart or table of data) is recited, the term “about” or “approximately” means that range which would encompass the recited value and the range which would be included by rounding up or down to the recited value as well, taking into account significant figures. In certain embodiments, the term “about” or “approximately” means within 10% or 5% of the specified value. Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values.

In some embodiments, the term “substantially all” means at least about 90%, 95%, 96%, 97%, 98% or 99%. In some embodiments, the term “substantially free” means no more than about 10 wt %, 5 wt %, 4 wt %, 3 wt %, 2 wt % or 1 wt %, or no more than about 1000 ppm, 500 ppm, 400 ppm, 300 ppm, 200 ppm or 100 ppm.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

It is not intended that any functional language used in any claims appended herein be construed as invoking 35 U.S.C. § 112(f) interpretation as “means-plus-function” language, unless specifically expressed as such by use of the term “means for” or “step(s) for” in a claim.

Any terms of orientation provided herein are merely for purposes of illustration and are not limiting of the invention. For example, a “top” layer may also be referred to as a second layer, and the “bottom” layer may also be referred to as a first layer. Other nomenclature and arrangements may be used without limitation of the teachings herein.

While some chemicals may be described herein as providing certain function(s), a given chemical may be useful for other purpose(s).

Various other components may be included and called upon to provide for aspects of the teachings herein. For example, additional materials, combinations of materials and/or omission of materials may be used to provide additional embodiments that are within the scope of the teachings herein.

A variety of modifications of the teachings herein may be realized. Generally, modifications may be designed according to the needs of a user, designer, manufacturer or other similarly interested party. The modifications may be intended to meet a particular standard of performance considered important by that party. Similarly, acceptability of performance is to be assessed by the appropriate user, designer, manufacturer or other similarly interested party.

The entire contents of each of the publications and patent applications cited herein are incorporated herein by reference. In the event that any of the cited documents conflicts with the present disclosure, the present disclosure shall control.

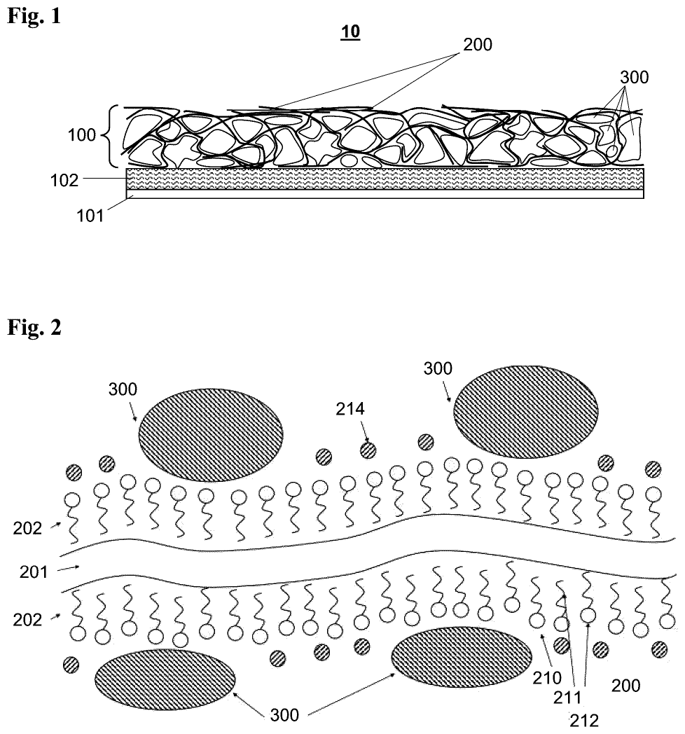

FIG. 1 shows an electrode 10 that includes an active layer 100 disposed on a current collector 101. Some embodiments may include an optional adhesion layer 102 disposed between the active layer 100 and the current collector 101. In other embodiments, the adhesion layer 102 may be omitted.

The current collector 101 may be an electrically conductive layer, such as a metal foil. The optional adhesion layer 102 (which may be omitted in some embodiments) may be a layer of material that promotes adhesion between the current collector 101 and the active layer 100. Examples of suitable materials for the current collector 101 and the optional adhesion layer 102 are described in International Patent Publication No. WO/2018/102652 published Jun. 7, 2018.

### Electrode Active Layer

As depicted in FIG. 2, in some embodiments the active layer 100 may include a three-dimensional network 200 of high aspect ratio carbon elements 201 defining void spaces within the network 200. A plurality of active material particles 300 are disposed in the void spaces within the network 200. Accordingly, the active material particles are enmeshed or entangled in the network 200, thereby improving the cohesion of the active layer 100.

In some embodiments, a surface treatment 202 is applied on the surface of the high aspect ratio carbon elements 201 of the network 200. The surface treatment promotes adhesion between the high aspect ratio carbon elements and the active material particles 300. The surface treatment may also promote adhesion between the high aspect ratio carbon elements and the current collector 101 (also referred to herein as a “conductive layer”) and/or the optional adhesion layer 102.

As used herein, the term “high aspect ratio carbon elements” refers to carbonaceous elements having a size in one or more dimensions (the “major dimension(s)”) significantly larger than the size of the elements in a transverse dimension (the “minor dimension”).

For example, in some embodiments the high aspect ratio carbon elements 201 may include flakes or plate-shaped elements having two major dimensions and one minor dimension. For example, in some such embodiments, the length of each of the major dimensions may be at least about 5 times, 10 times, 50 times, 100 times, 500 times, 1,000 times, 5,000 times, 10,000 times or more greater than that of the minor dimension. Exemplary elements of this type include graphene sheets and flakes.

For example, in some embodiments the high aspect ratio carbon elements 201 may include elongated rod or fiber-shaped elements having one major dimension and two minor dimensions. For example, in some such embodiments, the length of the major dimension may be at least about 5 times, 10 times, 50 times, 100 times, 500 times, 1,000 times, 5,000 times, 10,000 times or more greater than that of each of the minor dimensions. Exemplary elements of this type include carbon nanotubes, bundles of carbon nanotubes, carbon nanorods, and carbon fibers.

In some embodiments, the high aspect ratio carbon elements 201 may include carbon nanotubes (CNTs, including single-wall nanotubes (SWNT), double-wall nanotubes (DWNT), and/or multiwall nanotubes (MWNT)), carbon nanorods, or carbon fibers, or mixtures thereof. In some embodiments, the high aspect ratio carbon elements 201 may be formed of interconnected bundles, clusters, or aggregates of CNTs or other high aspect ratio carbon elements or materials. In some embodiments, the high aspect ratio carbon elements 201 may include graphene in sheet, flake, or curved flake form, and/or may be formed into high aspect ratio cones, rods, and the like.

In some embodiments, the electrode active layer 100 may contain little or no bulk binder material, leaving more space in the network 200 to be occupied by active material particles 300. For example, in some embodiments, the active layer 100 contains less than about 10% by weight, less than about 5% by weight, less than about 1% by weight, less than about 0.1% by weight, less than about 0.01% by weight, or less of binder material (e.g., polymeric or cellulosic binder material) disposed in the void spaces.

For example, in some embodiments the electrode active layer is free of or substantially free of binder material or polymeric material, or any material other than the active material 300, the network 200 composed of the high aspect ratio carbon elements 201, and the optional surface treatment 202 disposed thereon.

In some embodiments, the network 200 is composed largely or entirely of carbon. For example, in some embodiments the network 200 is at least about 90% carbon by weight, at least about 95% carbon by weight, at least about 96% carbon by weight, at least about 97% carbon by weight, at least about 98% carbon by weight, at least about 99% carbon by weight, at least about 99.5% carbon by weight, at least about 99.9% carbon by weight, or more.

In some embodiments, a size (e.g., the average size, median size, or minimum size) of the high aspect ratio carbon elements 201 forming the network 200 along one or two major dimensions may be at least about 0.1 μm, 0.5 μm, 1 μm, 5 μm, 10 μm, 50 μm, 100 μm, 200 μm, 300, μm, 400 μm, 500 μm, 600 μm, 700 μm, 800 μm, 900 μm, 1,000 μm or more. For example, in some embodiments the size (e.g., the average size, median size, or minimum size) of the high aspect ratio carbon elements 201 forming the network 200 may be in the range of about 1 μm to about 1,000 μm, or any subrange thereof, such as about 1-600 μm, 1-100 μm, 100-200 μm, 200-300 μm, 300-400 μm, 400-500 μm or 500-600 μm.

In some embodiments, the size of the high aspect ratio carbon elements 201 can be relatively uniform. For example, in some embodiments, more than about 50%, 60%, 70%, 80%, 90%, 95%, 99% or more of the elements 201 may have a size along one or two major dimensions within about 10% of the average size for the elements 201 making up the network 200.

The inventors have found that an active layer 100 of the type herein can provide exemplary performance (e.g., high conductivity, low resistance, high voltage performance, and high energy and power density) even when the mass fraction of high aspect ratio carbon elements 201 making up the network 200 in the layer 100 is quite low, thereby allowing high mass loading of active material particles 300. For example, in some embodiments, the active layer 100 may be at least about 50 wt % (percent by weight), 60 wt %, 70 wt %, 75 wt %, 80 wt %, 85 wt %, 90 wt %, 95 wt %, 96 wt % 97 wt %, 98 wt %, 99 wt %, 99.5 wt %, or more of active material particles 300.

In some embodiments, the network 200 forms an interconnected network of highly electrically conductive paths for current flow (e.g., electron or ion transport) through the active layer 100. For example, in some embodiments, highly conductive junctions may occur at points where the high aspect ratio carbon elements 201 of the network intersect with each other, or where they are in close enough proximity to each other to allow for quantum tunneling of charge carriers (e.g., electrons or ions) from one element to the next. While the elements 201 may make up a relatively low mass fraction of the active layer (e.g., less than about 10 wt %, 5 wt %, 4 wt %, 3 wt %, 2 wt %, 1 wt % or less, or in the range of about 0.5 wt % to about 10 wt % or any subrange thereof such as about 0.5 or 1 wt % to about 5 wt %), the interconnected network of highly electrically conductive paths formed in the network 200 may provide long conductive paths to facilitate current flow within and through the active layer 100 (e.g., conductive paths on the order of the thickness of the active layer 100).

For example, in some embodiments, the network 200 may include one or more structures of interconnected elements 201, where the structure has an overall length along one or more dimensions longer than about 2, 3, 4, 5, 10, 20, 50, 100, 500, 1,000, 10,000 times or more the average length of the component elements 201 making up the structure. For example, in some embodiments, network 200 may include one or more structures of interconnected elements 201, where the structure has an overall length in the range of about 2 to about 10,000 (or any subrange thereof) times the average length of the component elements 201 making up the structure. For example, in some embodiments the network 200 may include highly conductive pathways having a length greater than about 100 μm, 500 μm, 1,000 μm, 10,000 μm or more, e.g., in the range of about 100 μm-10,000 μm or any subrange thereof, such as about 100-1000 μm, 1000-2000 μm, 2000-3000 μm, 3000-4000 μm, 4000-5000 μm, 5000-6000 μm, 6000-7000 μm, 7000-8000 μm, 8000-9000 μm or 9000-10,000 μm.

As used herein, the term “highly conductive pathway” is to be understood as a pathway formed by interconnected elements 201 having an electrical conductivity higher than the electrical conductivity of the active material particles enmeshed in the network 200.

Not wishing to be bound by theory, in some embodiments the network 200 can be characterized as an electrically interconnected network of elements 201 exhibiting connectivity above a percolation threshold. Percolation threshold is a mathematical concept related to percolation theory, which is the formation of long-range connectivity in random systems. Below the threshold a so-called “giant” connected component of the order of system size does not exist; while above it, there exists a giant component of the order of system size.

In some embodiments, the percolation threshold can be determined by increasing the mass fraction of elements 201 in the active layer 100 while measuring the conductivity of the layer, holding all other properties of the layer constant. In some such cases, the threshold can be identified by the mass fraction at which the conductivity of the layer sharply increases and/or the mass fraction above which the conductivity of the layer increases only slowly with the addition of more elements 201. Such behavior is indicative of crossing the threshold required for the formation of interconnected structures that provide conductive pathways with a length on the order of the size of the active layer 100.

FIG. 2 shows high aspect ratio carbon element 201 of the network 200 (as shown in FIG. 1) in close proximity to several active material particles 300. In the embodiment shown in FIG. 2, the surface treatment 202 on the element 201 is a surfactant layer bonded to the outer layer of the surface of the element 201. As shown, the surfactant layer comprises a plurality of surfactant elements 210 each having a hydrophobic end or tail 211 and a hydrophilic end or head 212, wherein the hydrophobic end or tail 211 is disposed proximal to the surface of the carbon element 201 and the hydrophilic end or head 212 is disposed distal to the surface of the carbon element 201.

In some embodiments where the carbon element 201 is hydrophobic (as is typically the case with nanoform carbon elements such as CNTs, CNT bundles, and graphene flakes), the hydrophobic end or tail 211 of the surfactant element 210 will be attracted to the carbon element 201. Accordingly, in some embodiments, the surface treatment 202 may be a self-assembling layer. For example, as detailed below, in some embodiments, when the carbon elements 201 are mixed in a solvent with surfactant elements 210 to form a slurry, the surface treatment 202 layer self-assembles on the surface of the carbon elements 201 due to electrostatic interactions between the carbon elements 201 and the surfactant elements 210 within the slurry.

In some embodiments, the surface treatment 202 may a self-limiting layer. For example, as detailed below, in some embodiments, when the carbon elements 201 are mixed in a solvent with surfactant elements 210 to form a slurry, the surface treatment 202 layer self-assembles on the surface of the carbon elements 201 due to electrostatic interactions between the elements 201 and 210 within the slurry. In some such embodiments, once an area of the surface of a carbon element 201 is covered in surfactant elements 210, additional surfactant elements 210 will not be attracted to that area. In some embodiments, once the surface of a carbon element 201 is covered with surfactant elements 210, further surfactant elements are repulsed from the layer, resulting in a self-limiting process. For example, in some embodiments the surface treatment 202 may form in a self-limiting process, thereby ensuring that the layer will be thin, e.g., a single molecule or a few molecules thick.

In some embodiments, the hydrophilic ends or heads 212 of at least a portion of the surfactant elements 210 form covalent or non-covalent bonds with, or interact with, the active material particles 300. Accordingly, the surface treatment 202 can provide good adhesion between the high aspect ratio carbon elements 201 of the network 200 and the active material particles 300. In some embodiments, the bonds may be covalent bonds, or non-covalent bonds such as π-π bonds, hydrogen bonds, electrostatic bonds or combinations thereof, or the interaction may be van der Waals interaction.

For example, in some embodiments, the hydrophilic end or head 212 of the surfactant element 210 has a polar charge of a first polarity, while the surface of the active material particle 300 carries a polar charge of a second polarity opposite to that of the first polarity, and hence the two are attracted to each other.

For example, in some embodiments where, during formation of the active layer 100, the active material particles 300 are combined in a solvent with carbon elements 201 bearing the surface treatment 202 (as described in greater detail below), the outer surface of the active material particles 300 may be characterized by a Zeta potential (as is known in the art) having the opposite sign of the Zeta potential of the outer surface of the surface treatment 202. Accordingly, in some such embodiments, attraction between the carbon elements 201 bearing the surface treatment 202 and the active material particles 300 promotes the self-assembly of a structure in which the active material particles 300 are enmeshed with the carbon elements 201 of the network 200.

In some embodiments the hydrophilic ends or heads 212 of at least a portion of the surfactant elements 210 form covalent or non-covalent bonds with, or interact with, a current collector layer or an adhesion layer underlying the active material layer 100. Accordingly, the surface treatment 202 can provide good adhesion between the high aspect ratio carbon elements 201 of the network 200 and such underlying layer. In some embodiments, the bonds may be covalent bonds, or non-covalent bonds such as π-π bonds, hydrogen bonds, electrostatic bonds or combinations thereof, or the interaction may be van der Waals interaction. In some embodiments, this arrangement provides excellent mechanical stability of the electrode 10, as discussed below.

In some embodiments, the surfactant used to form the surface treatment 202 as described above may include any suitable material. For example, in some embodiments the surfactant may include one or more of the following: hexadecyltrimethylammonium hexafluorophosphate (CTAP), hexadecyltrimethylammonium tetrafluoroborate (CTAB), hexadecyltrimethylammonium acetate, hexadecyltrimethylammonium nitrate, hocamidopropyl betaine, N-(cocoalkyl)-N,N,N-trimethylammonium methyl sulfate, and cocamidopropyl betaine. Additional suitable surfactants and materials are described below.

In some embodiments, the surfactant layer 202 may be formed by dissolving a compound in a solvent, such that the layer of surfactant is formed from ions from the compound (e.g., in a self-limiting process as described above). In some such embodiments, the active layer 100 may include residual counterions 214 to the surfactant ions forming the surface treatment 202.

In some embodiments, the surfactant counterions 214 are selected to be compatible with use in an electrochemical cell. For example, in some embodiments, the counterions are selected to be unreactive or mildly reactive with materials used in the cell, such as an electrolyte, separator, housing, or the like. For example, if an aluminum housing is used, the counterion may be selected to be unreactive or mildly reactive with the aluminum housing.

For example, in some embodiments, the residual counterions are free or substantially free of halide groups. For example, in some embodiments, the residual counterions are free or substantially free of bromine/bromide.

In some embodiments, the residual counterions may be selected to be compatible with an electrolyte used in an energy storage cell containing the active layer 100. For example, in some embodiments, residual counterions may be the same species of ions used in the electrolyte itself. For example, if the electrolyte includes a dissolved LiPF₆ salt, the electrolyte anion is PF₆. In such a case, the surfactant may be selected as, e.g., CTA PF₆, such that the surface treatment 202 is formed as a layer of anions from the CTA PF₆, while the residual surfactant counterions are the PF₆ anions from the CTA PF₆ (thus matching the anions of the electrolyte).

In some embodiments, the surfactant material used may be soluble in a solvent which exhibits advantageous properties. For example, in some embodiments, the solvent may include water or/and an alcohol such as methanol, ethanol or 2-propanol (isopropyl alcohol, sometimes referred to as IPA), or a combination thereof. In some embodiments, the solvent may include one or more additives used to further improve the properties of the solvent, e.g., low boiling point additives such as acetonitrile (ACN), de-ionized water, and tetrahydrofuran.

For example, if a low boiling point solvent is used in the formation of the surface treatment 202, the solvent may be quickly removed using a thermal drying process (e.g., of the type described in greater detail below) performed at a relatively low temperature. As will be understood by those skilled in the art, this can improve the speed and/or cost of manufacture of the active layer 100.

For example, in some embodiments, the surface treatment 202 is formed from a material which is soluble in a solvent having a boiling point less than about 250° C., 225° C., 202° C., 200° C., 185° C., 180° C., 175° C., 150° C., 125° C., 100° C. or less, e.g., less than or equal to about 100° C.

In some embodiments, the solvent may exhibit other advantageous properties. In some embodiments the solvent may have a low viscosity, such as a viscosity at about 20° C. of less than or equal to about 3.0 centipoise, 2.5 centipoise, 2.0 centipoise, 1.5 centipoise, 1.0 centipoise, or less. In some embodiments the solvent may have a low surface tension such as a surface tension at about 20° C. of less than or equal to about 40 mN/m, 35 mN/m, 30 mN/m, 25 mN/m, 20 mN/m, or less. In some embodiments, the solvent may have a low toxicity, e.g., toxicity comparable to alcohols such as isopropyl alcohol.

The present disclosure notably contrasts with the process used to form conventional electrode active layers featuring bulk binder materials such as polyvinylidene fluoride or polyvinylidene difluoride (PVDF). Such bulk binders require aggressive solvents often characterized by high boiling points. One such example is N-methyl-2-pyrrolidone (NMP). Use of NMP (or other pyrrolidone-based solvents) as a solvent requires the use of high temperate drying processes to remove the solvent. Moreover, NMP is expensive, requiring a complex solvent-recovery system, and is highly toxic, posing significant safety issues. In contrast, as detailed below, in some embodiments the active layer 100 may be formed without the use of NMP or similar compounds such as pyrrolidone-based compounds.

While exemplary embodiments of surface treatment 202 are described above, it is understood that other treatments may be used. For example, in some embodiments the surface treatment 202 may be formed by functionalizing the high aspect ratio carbon elements 201 using any suitable technique as described herein or known in the art. Functional groups applied to the elements 201 may be selected to promote adhesion between the active material particles 300 and the network 200. For example, in some embodiments the functional groups may include carboxyl groups, carbonyl groups, ester groups, hydroxyl groups, thiol groups, amine groups, silane groups, phosphate groups, or combinations thereof.

As described in greater detail below, in some embodiments, the functionalized carbon elements 201 are formed from dried (e.g., lyophilized) aqueous dispersion comprising nanoform carbon and functionalizing material such as a surfactant. In some such embodiments, the aqueous dispersion is substantially free of materials that would damage the carbon elements 201, such as acids.

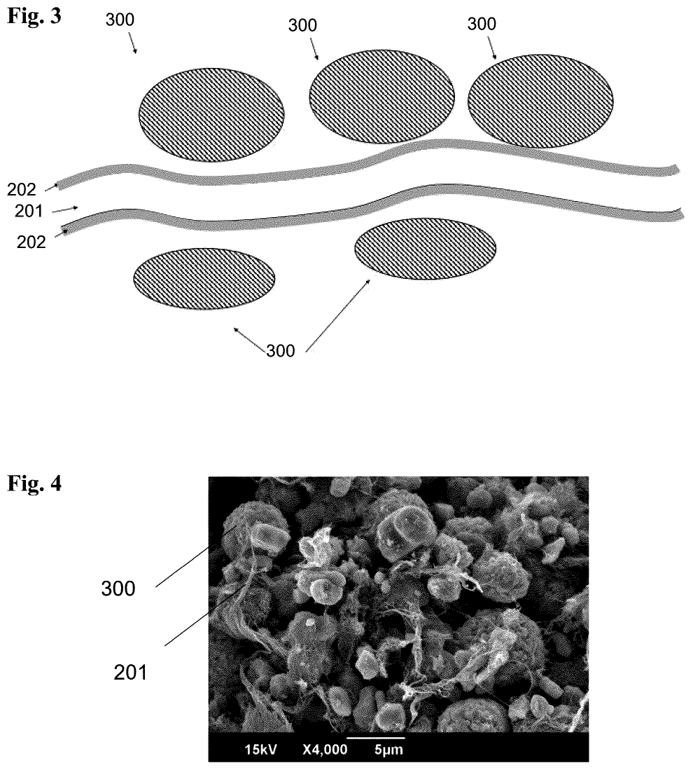

Referring to FIG. 3, in some embodiments, the surface treatment 202 of the high aspect ratio carbon elements 201 includes a thin polymeric layer disposed on the carbon elements that promotes adhesion of the active material to the network. In some such embodiments, the thin polymeric layer comprises a self-assembled and/or self-limiting polymer layer. In some embodiments, the thin polymeric layer bonds to or interacts with the active material, e.g., via hydrogen bonding and/or van der Waals force.

In some embodiments, the thin polymeric layer may have a thickness in the direction normal to the outer surface of the carbon elements of less than about 3 times, 2 times, 1 times, 0.5 times, 0.1 times, or less that of the minor dimension of the carbon elements 201.

In some embodiments, the thin polymeric layer includes functional groups (e.g., side functional groups such as aromatic groups, carboxyl groups, carbonyl groups, ester groups, hydroxyl groups, thiol groups, amine groups, silane groups, phosphate groups, or a combination thereof) that bond to the active material, e.g., via non-covalent bonding such a π-π bonding, hydrogen bonding, electrostatic bonding or ionic bonding. In some such embodiments, the thin polymeric layer may form a stable covering layer over at least a portion of the carbon elements 201.

In some embodiments, the thin polymeric layer on some of the carbon elements 201 may bond with a current collector 101 or an adhesion layer 102 underlying the active layer 100. For example, in some embodiments the thin polymeric layer includes side functional groups (e.g., aromatic groups, carboxyl groups, carbonyl groups, ester groups, hydroxyl groups, thiol groups, amine groups, silane groups, phosphate groups, or a combination thereof) that bond to the surface of the current collector 101 or the adhesion layer 102, e.g., via non-covalent bonding such a π-π bonding, hydrogen bonding, electrostatic bonding or ionic bonding. In some such embodiments, the thin polymeric layer may form a stable covering layer over at least a portion of the carbon elements 201. In some embodiments, this arrangement provides excellent mechanical stability of the electrode 10, as discussed in greater detail below.

In some embodiments, the polymeric material is miscible in solvents of the type described in the examples above. For example, in some embodiments the polymeric material is miscible in a solvent that includes an alcohol such as methanol, ethanol or 2-propanol (isopropyl alcohol), or a combination thereof. In some embodiments, the solvent may include one or more additives used to further improve the properties of the solvent, e.g., low boiling point additives such as acetonitrile, de-ionized water, and tetrahydrofuran.

Suitable examples of materials which may be used to form the polymeric layer include water-soluble polymers such as polyvinylpyrrolidone. Additional exemplary materials are provided below.

In some embodiments, the polymeric material has a low molecular mass, e.g., less than or equal to about 1,000,000 g/mol, 500,000 g/mol, 100,000 g/mol, 50,000 g/mol, 10,000 g/mol, 5,000 g/mol, 2,500 g/mol or less.

The thin polymeric layer described above is qualitatively distinct from bulk polymer binders used in conventional electrodes. Rather than filling a significant portion of the volume of the active layer 100, the thin polymeric layer resides on the surface of the high aspect ratio carbon elements 201, leaving the vast majority of the void space within the network 200 available to hold active material particles 300.

For example, in some embodiments, the thin polymeric layer has a maximum thickness in a direction normal to an outer surface of the network of less than or equal to about 1 times, 0.5 times, 0.25 times, 0.1 times or less the size of the carbon elements 201 along their minor dimensions. For example, in some embodiments the thin polymeric layer may be only a few molecules thick (e.g., less than or equal to about 100, 50, 10, 5, 4, 3, 2 or 1 molecule(s) thick). Accordingly, in some embodiments, less than about 10%, 5%, 1%, 0.1%, 0.01%, 0.001% or less of the volume of the active layer 100 is occupied by the thin polymeric layer.

In further embodiments, the surface treatment 202 may form a layer of carbonaceous material that results from pyrolysis of polymeric material disposed on the high aspect ratio carbon elements 201. This layer of carbonaceous material (e.g., graphitic or amorphous carbon) may attach (e.g., via covalent or non-covalent bonds or van der Waals force) to or otherwise promote adhesion with the active material particles 300. Examples of suitable pyrolysis techniques are described in U.S. Patent Application Ser. No. 63/028,982 filed May 22, 2020. One suitable polymeric material for use in this technique is polyacrylonitrile (PAN).

In some embodiments, the active material particles 300 may include any active material suitable for use in energy storage devices, including metal oxides such as lithium metal oxides for the active layer of the cathode, for example. For example, the active material particles 300 of the active layer of the cathode, for example, may include lithium cobalt oxide (LCO, sometimes called “lithium cobaltate” or “lithium cobaltite”, is a chemical compound with one variant of possible formulations being LiCoO₂); lithium nickel manganese cobalt oxide (NMC, with variant formulas of LiNiₓMn_{y}Co_{1-x-y}O₂ where x+y+(1−x−y)=1.0, such as LiNi_{0.33}Mn_{0.33}Co_{0.33}O₂ [NMC111], LiNi_{0.5}Mn_{0.3}Co_{0.2}O₂[NMC532], LiNi_{0.6}Mn_{0.2}Co_{0.2}O₂[NMC622] and LiNi_{0.7}Mn_{0.2}Co_{0.1}O₂ [NMC721]); lithium nickel manganese oxide (LNMO, with one variant formula being LiNi_{0.5}Mn_{1.5}O₄,); lithium manganese oxide (LMO with variant formulas of LiMnO₂, LiMn₂O₄, Li₂MnO₃ and others); lithium nickel cobalt aluminum oxide (NCA, with variant formulas of LiNiₓCo_{y}Al_{z}O₂ where x+y+z=1.0, such as LiNi_{0.8}Co_{0.15}Al_{0.05}O₂ and LiNi_{0.84}Co_{0.12}Al_{0.04}O₂); lithium titanate oxide (LTO, with one variant formula being Li₄Ti₅O₁₂); lithium iron phosphate (LFP, LiFePO₄); as well as other similar materials. Other variants of the foregoing may be included.

In some embodiments where NMC is used as an active material, a nickel-dominant or nickel-rich NMC may be used. For a nickel-rich NMC, in some embodiments the variant of NMC may be LiNiₓMn_{y}Co_{1-x-y}O₂, where x is equal to or greater than about 0.7, 0.75, 0.8, 0.85, 0.9 or more, which includes NMC721 and NMC811. In some embodiments, so-called NMC811 (LiNi_{0.8}Mn_{0.1}Co_{0.1}O₂) may be used, where in the foregoing formula x is about 0.8 and y is about 0.1. For a nickel-dominant NMC, in some embodiments x in the above formula is at least 0.5, which includes NMC532 and NMC622. Likewise, in some embodiments a nickel-dominant NCA having x≥0.5, or a nickel-rich NCA having x≥about 0.7, 0.75, 0.8, 0.85 or 0.9, in the general formula LiNiₓCo_{y}Al_{z}O₂ may be used as a cathode active material. An example of a nickel-rich NCA is LiNi_{0.889}Co_{0.097}Al_{0.015}O₂ (NCA90). A nickel-rich NMC or NCA contains a lower amount of cobalt, an expensive metal, and thus costs less. In addition, increasing the nickel content increases the voltage and thus the amount of energy that can be stored in the battery.

In some embodiments, the active material includes other forms of lithium nickel manganese cobalt oxide (e.g., LiNiₓMn_{y}Co_{z}O₂). For example, common variants such as NMC111 (LiNi_{0.33}Mn_{0.33}Co_{0.33}O₂), NMC532 (LiNi_{0.5}Mn_{0.3}Co_{0.2}O₂), NMC622 (LiNi_{0.6}Mn_{0.2}Co_{0.2}O₂), and others may be used.

In some embodiments, e.g., where the electrode is used as an anode, the active material may include graphite, hard carbon, activated carbon, nanoform carbon, silicon, silicon oxides, carbon-encapsulated silicon nanoparticles, or a combination thereof. In some such embodiments, the active layer 100 may be intercalated with lithium, e.g., using pre-lithiation methods known in the art.

In some embodiments, the techniques described herein may allow for the active layer 100 to be composed of a high percentage of active material in the active layer (e.g., greater than about 75%, 80%, 85%, 90%, 95%, 99%, 99.5%, 99.8% or more of active material by weight), while still exhibiting excellent mechanical properties (e.g., lack of delamination during operation in an energy storage device of the types described herein). For example, in some embodiments, the active layer may have a high percentage of active material and a large thickness (e.g., greater than about 50 μm, 100 μm, 150 μm, 200 μm, or more), while still exhibiting excellent mechanical properties (e.g., a lack of delamination during operation in an energy storage device of the types described herein).

The active material particles 300 in the active layer 100 may be characterized by a median particle size (e.g., diameter) in the range of, e.g., about 0.1 μm and about 50 μm, or any subrange thereof, such as about 0.1-1 μm, 1-10 μm, 10-20 μm, 20-30 μm, 30-40 μm or 40-50 μm. The active material particles 300 in the active layer 100 may be characterized by a particle size distribution which is monomodal, bi-modal or multi-modal particle size distribution. The active material particles 300 may have a specific surface area in the range of about 0.1 meter squared per gram (m²/g) and about 100 meters squared per gram (m²/g), or any subrange thereof, such as about 0.1-1 m²/g, 1-25 m²/g, 25-50 m²/g, 50-75 m²/g or 75-100 m²/g.

In some embodiments, the active layer 100 may have mass loading of active material particles 300 of, e.g., at least about 20 mg/cm², 30 mg/cm², 40 mg/cm², 50 mg/cm², 60 mg/cm², 70 mg/cm², 80 mg/cm², 90 mg/cm², 100 mg/cm², or more.

FIG. 4 shows an electron micrograph of an exemplary active layer of the type described herein. Tendril-like high aspect ratio carbon elements 201 (formed of CNT bundles) enmesh the active material particles 300. No bulky polymeric material takes up space within the active layer.

### Energy Storage Cell

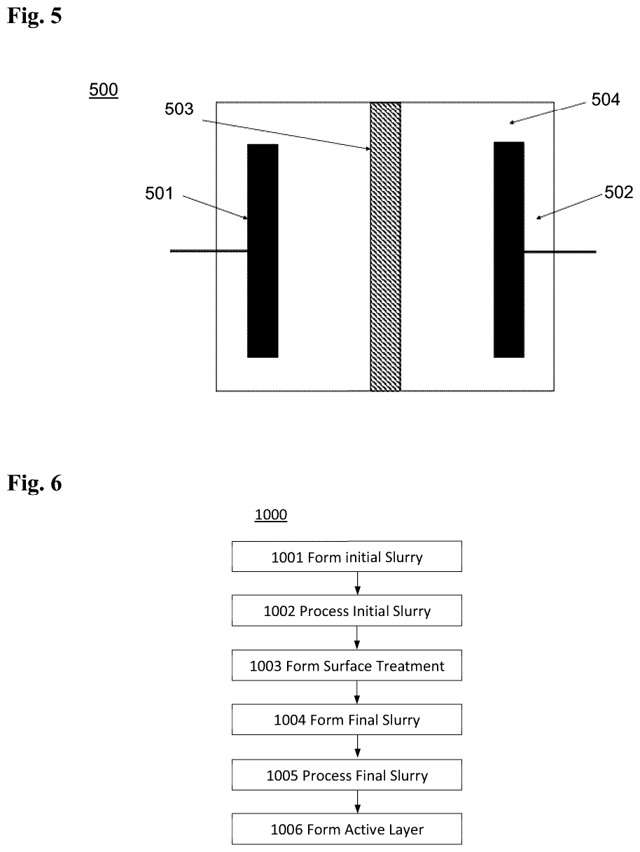

FIG. 5 shows an energy storage cell 500 that includes a first electrode 501, a second electrode 502, a permeable separator 503 disposed between the first electrode 501 and the second electrode 502, and an electrolyte 504 wetting the first and second electrodes. One or both of the electrodes 501 and 502 may be of the type described herein.

In some embodiments, the energy storage cell 500 may be a battery, such as a lithium-ion battery. In some such embodiments, the electrolyte may be a lithium salt dissolved in a solvent, e.g., of the types described in Qi Li, Juner Chen, Lei Fan, Xueqian Kong, Yingying Lu, Progress in electrolytes for rechargeable Li-based batteries and beyond, Green Energy & Environment, Volume 1, Issue 1, Pages 18-42, the entire contents of which are incorporated herein by reference.

In some such embodiments, the energy storage cell may have an operational voltage in the range of about 1.0 V to about 5.0 V, or any subrange thereof such as about 2.3 V-4.3 V, 1.0 V-3.0 V or 3.0 V-5.0 V, or an operational voltage of at least about 2.0 V, 2.5 V, 3.0 V, 3.5 V or 4.0V.

In some such embodiments, the energy storage cell 500 may have an operating temperature range from about ⁻40° C. to about 100° C. or 150° C., or any subrange thereof such as from about ⁻10° C. to about 100° C. or 150° C., or from about ⁻10° C. to about 60° C., or an operating temperature of at least about 50° C., 60° C., 80° C. or 100° C.

In some such embodiments, the energy storage cell 500 may have a gravimetric energy density of at least about 100 Wh/kg, 200 Wh/kg, 300 Wh/kg, 400 Wh/kg, 500 Wh/kg, 1000 Wh/kg or more.

In some such embodiments, the energy storage cell 500 may have a volumetric energy density of at least about 200 Wh/L, 400 Wh/L, 600 Wh/L, 800 Wh/L, 1000 Wh/L, 1500 Wh/L, 2000 Wh/L or more.

In some such embodiments, the energy storage cell 500 may have a C rate in the range of about 0.1 to about 50, or any subrange thereof such as about 1-10, 10-30 or 30-50, or a C rate of at least about 1, 2, 5, 10, 20 or 30.

In some such embodiments, the energy storage cell 500 may have a cycle life of at least about 1000, 1500, 2000, 2500, 3000, 3500, 4000, 5000 or more charge/discharge cycles.

In some embodiments, the energy storage cell 500 may be a lithium-ion capacitor of the type described in U.S. Provisional Pat. App. No. 63/021,492 filed May 8, 2020, the entire contents of which are incorporated herein by reference.

In some such embodiments, the energy storage cell may have an operating voltage in the range of about 2.0 V to about 5.0 V, or any subrange thereof such as about 2.0 V-4.0 V, or an operating voltage of at least about 2.0 V, 2.5 V, 3.0 V, 3.5 V or 4.0V.

In some such embodiments, the energy storage cell 500 may have an operating temperature range from about ⁻60° C. to about 100° C. or 150° C., or any subrange thereof such as from about ⁻40° C. to about 100° C. or 150° C., or from about ⁻40° C. to about 85° C., or an operating temperature of at least about 60° C., 80° C. or 100° C.

In some such embodiments, the energy storage cell 500 may have a gravimetric energy density of at least about 10 Wh/kg, 15 Wh/kg, 20 Wh/kg, 30 Wh/kg, 40 Wh/kg, 50 Wh/kg, 100 Wh/kg or more.

In some such embodiments, the energy storage cell 500 may have a volumetric energy density of at least about 20 Wh/L, 30 Wh/L, 40 Wh/L, 50 Wh/L, 60 Wh/L, 70 Wh/L, 80 Wh/L, 100 Wh/L, 150 Wh/L, 200 Wh/L or more.

In some such embodiments, the energy storage cell 500 may have a gravimetric power density of at least about 5 kW/kg, 7.5 W/kg, 10 kW/kg, 12.5 kW/kg, 14 kW/kg, 15 kW/kg, 20 kW/kg, 30 kW/kg, 40 kW/kg, 50 kW/kg or more.

In some such embodiments, the energy storage cell 500 may have a volumetric power density of at least about 10 kW/L, 15 kW/L, 20 kW/L, 22.5 kW/L, 25 kW/L, 28 kW/L, 30 kW/L, 50 kW/L, 100 kW/L or more.

In some such embodiments, the energy storage cell 500 may have a C rate in the range of about 1.0 to about 100, or any subrange thereof such as about 1-25, 25-50, 50-75 or 75-100, or a C rate of at least about 10, 20, 30, 40 or 50.

In some such embodiments, the energy storage cell 500 may have a cycle life of at least about 100,000, 500,000, 1,000,000 or more charge/discharge cycles.

### Fabrication Methods

The electrode 10 comprising active layer 100 as described herein may be made using any suitable manufacturing process. As will be understood by one skilled in the art, in some embodiments the electrode 10 may be made using wet coating techniques of the types described in International Patent Publication No. WO 2018/102652 A1 in further view of the disclosure herein.

FIG. 6 outlines an exemplary method 1000 for forming the active layer 100 of electrode 10. In step 1001 high aspect ratio carbon elements 201 and a surface treatment material (e.g., a surfactant or polymer material as described herein) are combined with a solvent (of the type described herein) to form an initial slurry.

In step 1002 the initial slurry is processed to ensure good dispersion of the solid materials in the slurry. In some embodiments, this processing includes introducing mechanical energy into the mixture of solvent and solid materials (e.g., using a sonicator, which is sometimes referred to as a “sonifier”) or other suitable mixing device (e.g., a high shear mixer). In some embodiments, the mechanical energy introduced into the mixture is at least about 0.4 kilowatt-hours per kilogram (kWh/kg), 0.5 kWh/kg, 0.6 kWh/kg, 0.7 kWh/kg, 0.8 kWh/kg, 0.9 kWh/kg, 1.0 kWh/kg, or more. For example, the mechanical energy introduced into the mixture per kilogram of mixture may be in the range of about 0.4 kWh/kg to about 1.0 kWh/kg, or any subrange thereof such as about 0.4 kWh/kg to about 0.6 kWh/kg.

In some embodiments an ultrasonic bath mixer may be used. In other embodiments, a probe sonicator may be used. Probe sonication may be significantly more powerful and effective when compared to ultrasonic baths for nanoparticle applications. High shear forces created by ultrasonic cavitation have the ability to break up particle agglomerates and result in smaller and more uniform particle sizes. Among other things, sonication can result in stable and homogenous suspensions of the solids in the slurry. Generally, this results in dispersing and deagglomerating and other breakdown of the solids. Examples of probe sonication devices include the Q Series Probe Sonicators available from QSonica LLC of Newtown, Connecticut. Another example includes the Branson Digital SFX-450 sonicator available commercially from Thomas Scientific of Swedesboro, New Jersey.

The localized nature of each probe within the probe assembly, however, may result in uneven mixing and suspension. Such may be the case, e.g., with large samples. This may be countered by use of a setup with a continuous flow cell and proper mixing. With such a setup, mixing of the slurry achieves reasonably uniform dispersion.

In some embodiments, the initial slurry, once processed, has a viscosity in the range of about 5,000 cps to about 25,000 cps, or any subrange thereof such as about 6,000 cps to about 19,000 cps.

In step 1003, the surface treatment 202 may be fully or partially formed on the high aspect ratio carbon elements 201 in the initial slurry. In some embodiments, at this stage the surface treatment 202 may self-assemble as described above with reference to FIGS. 2 and 3. The resulting surface treatment 202 may include functional groups or other features which, as described in further steps below, may promote adhesion between the high aspect ratio carbon elements 201 and the active material particles 300.

In step 1004 the active material particles 300 may be combined with the initial slurry to form a final slurry containing the active material particles 300 along with the high aspect ratio carbon elements 201 with the surface treatment 202 formed thereon.

In some embodiments, the active material 300 may be added directly to the initial slurry. In other embodiments, the active material 300 may first be dispersed in a solvent (e.g., using the techniques described above with respect to the initial solvent) to form an active material slurry. The active material slurry may then be combined with the initial slurry to form the final slurry.

In step 1005 the final slurry is processed to ensure good dispersion of the solid materials in the final slurry. In some embodiments, any suitable mixing process known in the art may be used. In some embodiments, the processing of the final slurry may use the techniques described above with respect to step 1002. In some embodiments, a planetary mixer such as a multi-axis (e.g., three or more axes) planetary mixer may be used. In some such embodiments, the planetary mixer can feature multiple blades, such as two or more mixing blades and one or more (e.g., two, three or more) dispersion blades such as disk dispersion blades.

In step 1005, in some embodiments the matrix 200 enmeshing the active material 300 may fully or partially self-assemble, as described above with reference to FIGS. 2 and 3. In some embodiments, interactions between the surface treatment 202 and the active material 300 promote the self-assembly process.

In some embodiments, the final slurry, once processed, has a viscosity in the range of about 1,000 cps to about 10,000 cps, or any subrange thereof such as about 2,500 cps to about 6,000 cps.

In step 1006, the active layer 100 is formed from the final slurry. In some embodiments, the final slurry may be cast wet directly onto the current collector conductive layer 101 (or the optional adhesion layer 102) and dried. As an example, casting may be by applying heat or/and vacuum until substantially all of the solvent and any other liquids have been removed, thereby forming the active layer 100. In some such embodiments, it may be desirable to protect various parts of the underlying layer(s). For example, it may be desirable to protect an underside of the conductive layer 101 where the electrode 10 is intended for two-sided operation. Protection may include, e.g., protection from the solvent by masking certain areas, or providing a drain to direct the solvent away.

In other embodiments, the final slurry may be at least partially dried elsewhere and then transferred onto the conductive layer 101 or the optional adhesion layer 102 to form the active layer 100, using any suitable technique (e.g., roll-to-roll layer application). In some embodiments, the wet combined slurry may be placed onto an intermediate material with an appropriate surface and dried to form the layer (i.e., the active layer 100). While any material with an appropriate surface may be used as the intermediate material, an exemplary intermediate material is PTFE as subsequent removal from the surface is facilitated by its properties. In some embodiments, the designated layer is formed in a press to provide a layer that exhibits a desired thickness, area and density.

In some embodiments, the final slurry may be formed into a sheet, and coated onto the conductive layer 101 or the optional adhesion layer 102 as appropriate. For example, in some embodiments, the final slurry may be applied through a slot die to control the thickness of the applied layer. In other embodiments, the slurry may be applied and then leveled to a desired thickness, e.g., using a doctor blade. A variety of other techniques may be used for applying the slurry. For example, coating techniques may include without limitation comma coating, comma reverse coating, doctor blade coating, slot die coating, direct gravure coating, air doctor coating (air knife), chamber doctor coating, off set gravure coating, one roll kiss coating, reverse kiss coating with a small diameter gravure roll, bar coating, three reverse roll coating (top feed), three reverse roll coating (fountain die), reverse roll coating, and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and about 1,000 cps. In some applications, a respective layer may be formed by multiple passes.

In some embodiments, the active layer 100 formed from the final slurry may be compressed (e.g., using a calendering apparatus) before or after being applied to the current collector. In some embodiments, the slurry may be partially or completely dried (e.g., by applying heat, vacuum or a combination thereof) prior to or during the compression process. For example, in some embodiments, the active layer may be compressed to a final thickness (e.g., in the direction normal to the current collector layer 101) of less than about 90%, 80%, 70%, 60%, 50%, 40%, 30%, 20%, 10% or less of its pre-compression thickness.

In some embodiments, when a partially dried layer is formed during a coating or compression process, the layer may be subsequently fully dried, (e.g., by applying heat, vacuum or a combination thereof). In some embodiments, substantially all of the solvent is removed from the active layer 100.

In some embodiments, solvents used in formation of the slurries are recovered and recycled into the slurry-making process.

In some embodiments, the active layer may be compressed, e.g., to break some of the constituent high aspect ratio carbon elements or other carbonaceous material to increase the surface area of the respective layer. In some embodiments, the compression treatment may increase adhesion between the layers, ion transport rate within the layer(s), or the surface area of the layer(s), or any combination or all thereof. In some embodiments, compression can be applied before or after the respective layer is applied to or formed on the electrode 10.

In some embodiments where calendering is used to compress the active layer 100, the calendering apparatus may be set with a gap spacing equal to less than about 90%, 80%, 70%, 60%, 50%, 40%, 30%, 20%, 10% or less of the layer's pre-compression thickness (e.g., set to about 33% of the layer's pre-compression thickness). The calendar rolls can be configured to provide suitable pressure, e.g., greater than about 1, 1.5, 2 or 2.5 ton per cm of roll length, or more. In some embodiments, the post-compression active layer may have a density in the range of about 1 g/cc to about 10 g/cc, or any subrange thereof such as about 2.5 g/cc to about 4.0 g/cc. In some embodiments, the calendering process may be carried out at a temperature in the range of about 20° C. to about 140° C., or any subrange thereof such as about 50-100° C. or 50-75° C. In some embodiments, the active layer may be pre-heated prior to calendering, e.g., at a temperature in the range of about 20° C. to about 100° C., or any subrange thereof such as about 50-75° C.

Once the electrode 10 has been assembled, the electrode 10 may be used to assemble the energy storage device. Assembly of the energy storage device may follow conventional steps used for assembling electrodes with separators and placement within a housing such as a canister or pouch, and may include additional steps for electrolyte addition and sealing of the housing.

In some embodiments, process 1000 may include any of the following features (individually or in any suitable combination).

In some embodiments, the initial slurry has a solid content in the range of about 0.1%-20.0% by weight, or any subrange thereof such as about 1-20 wt % or 5-15 wt %. In some embodiments, the final slurry has a solid content in the range of about 10.0%-80% by weight, or any subrange thereof such as about 40-80 wt % or 40-60 wt %.

In some embodiments, the solvent used may be any of those described herein with respect to the formation of the surface treatment 202. In some embodiments, the surfactant material used to form the surface treatment 202 may be soluble in a solvent which exhibits advantageous properties. For example, in some embodiments, the solvent may include water or/and an alcohol such as methanol, ethanol or 2-propanol (isopropyl alcohol), or a combination thereof. In some embodiments, the solvent may include one or more additives used to further improve the properties of the solvent, e.g., low boiling point additives such as acetonitrile, de-ionized water, and tetrahydrofuran.

In some embodiments, if a low boiling point solvent is used, the solvent may be quickly removed using a thermal drying process performed at a relatively low temperature. This can improve the speed and/or the cost of manufacture of the electrode 10. For example, in some embodiments, the solvent may have a boiling point less than about 250° C., 225° C., 202° C., 200° C., 185° C., 180° C., 175° C., 150° C., 125° C., 100° C. or less, e.g., less than or equal to 100° C.

In some embodiments, the solvent may exhibit other advantageous properties. In some embodiments the solvent may have a low viscosity, such as a viscosity at about 20° C. of less than or equal to about 3.0 centipoise, 2.5 centipoise, 2.0 centipoise, 1.5 centipoise, 1.0 centipoise or less. In some embodiments, the solvent may have a low surface tension, such as a surface tension at about 20° C. of less than or equal to about 40 mN/m, 35 mN/m, 30 mN/m, 25 mN/m, 20 mN/m or less. In some embodiments, the solvent may have a low toxicity, e.g., toxicity comparable to that of alcohols such as isopropyl alcohol.

In some embodiments, during the formation of the active layer, a material forming the surface treatment may be dissolved in a solvent substantially free of pyrrolidone compounds. In some embodiments, the solvent is substantially free of N-methyl-2-pyrrolidone.

In some embodiments, the surface treatment 202 is formed from a material that includes a surfactant of the type described herein.

In some embodiments, dispersing high aspect ratio carbon elements and a surface treatment material in a solvent to form an initial slurry comprises applying forces to agglomerated carbon elements to cause the elements to slide apart from each other along a direction transverse to a minor axis of the elements. In some embodiments, techniques for forming such dispersions may be adapted from those disclosed in International Patent Publication No. WO 2018/102652 A1 in further view of the disclosure herein.

In some embodiments, the high aspect ratio carbon elements 201 can be functionalized prior to forming a slurry used to form the electrode 10. For example, in one aspect a method is disclosed that includes dispersing high aspect ratio carbon elements 201 and a surface treatment material in an aqueous solvent to form an initial slurry, wherein said dispersion step results in the formation of a surface treatment on the high aspect ratio carbon elements; and drying the initial slurry to remove substantially all moisture, resulting in a dried powder of the high aspect ratio carbon elements with the surface treatment thereon. In some embodiments, the dried powder may be combined, e.g., with a slurry of solvent and active material to form a final slurry of the type described above with reference to method 1000.

In some embodiments, drying the initial slurry comprises lyophilizing (freeze-drying) the initial slurry. In some embodiments, the aqueous solvent and initial slurry are substantially free of substances damaging to the high aspect ratio carbon elements. In some embodiments, the aqueous solvent and initial slurry are substantially free of acids. In some embodiments, the initial slurry consists essentially of the high aspect ratio carbon elements, the surface treatment material, and water.

Some embodiments further include dispersing the dried powder of the high aspect ratio carbon elements with the surface treatment material in a solvent and adding an active material to form a secondary slurry; coating the secondary slurry onto a substrate; and drying the secondary slurry to form an electrode active layer. In some embodiments, the preceding steps can be performed using techniques adapted from those disclosed in International Patent Publication No. WO/2018/102652 A1 in further view of the disclosure herein.

In some embodiments, the final slurry may include polymer additives such as polyacrylic acid (PAA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), and polyvinyl pyrrolidone (PVP). In some embodiments, the active layer may be treated by applying heat to pyrolyze the additive such that the surface treatment 202 may be formed on a layer of carbonaceous material which results from the pyrolysis of the polymeric additive. This layer of carbonaceous material (e.g., graphitic or amorphous carbon) may attach (e.g., via covalent or non-covalent bonds) to or interact with, or otherwise promote adhesion with, the active material particles 300. The heat treatment may be applied by any suitable means, e.g., by application of a laser beam. Examples of suitable pyrolysis techniques are described in U.S. Provisional Application No. 63/028,982 filed May 22, 2020.

### Surfactants

The techniques described above include the use of surfactants to form a surface treatment 202 on high aspect ratio carbon elements (e.g., nanotubes) 201 in order to promote adhesion with the active material particles 300. While several suitable surfactants have been described, it is understood that other surfactants, including the following, may be used.

Surfactants are molecules or groups of molecules having surface activity, including wetting agents, dispersants, emulsifiers, detergents, and foaming agents. A variety of surfactants can be used in the preparation of surface treatments as described herein. Typically, the surfactants used contain a lipophilic, nonpolar hydrocarbon group and a polar functional hydrophilic group. The polar functional group can be, e.g., a carboxylic, carboxylate, ester, amine, amide, imide, hydroxyl, ether, nitrile, phosphate, sulfate, or sulfonate. The surfactants can be used alone or in combination. Accordingly, a combination of surfactants can include anionic, cationic, nonionic, zwitterionic, amphoteric, and/or ampholytic surfactants, so long as there is a net positive or negative charge in the head regions of the population of surfactant molecules, or the head region of the surfactant is hydrophilic. In some instances, a single negatively charged or positively charged surfactant is used in the preparation of the present electrode compositions.

A surfactant used in the preparation of the present electrode compositions can be anionic, including, but not limited to, sulfonates such as alkyl sulfonates, alkylbenzene sulfonates, alpha olefin sulfonates, paraffin sulfonates, and alkyl ester sulfonates; sulfates such as alkyl sulfates, alkyl alkoxy sulfates, and alkyl alkoxylated sulfates; phosphates such as monoalkyl phosphates and dialkyl phosphates; phosphonates; carboxylates such as fatty acids, alkyl alkoxy carboxylates, sarcosinates, isethionates, and taurates. Specific examples of carboxylates are sodium oleate, sodium cocoyl isethionate, sodium methyl oleoyl taurate, sodium laureth carboxylate, sodium trideceth carboxylate, sodium lauryl sarcosinate, lauroyl sarcosine, and cocoyl sarcosinate. Specific examples of sulfates include sodium dodecyl sulfate (SDS), sodium lauryl sulfate, sodium laureth sulfate, sodium trideceth sulfate, sodium tridecyl sulfate, sodium cocyl sulfate, and lauric monoglyceride sodium sulfate.

Suitable sulfonate surfactants include, but are not limited to, alkyl sulfonates, aryl sulfonates, monoalkyl and dialkyl sulfosuccinates, and monoalkyl and dialkyl sulfosuccinamates. Each alkyl group independently contains about two to twenty carbon atoms and can also be ethoxylated with up to about 8 units, preferably up to about 6 units, on average, for example, 2, 3, or 4 units, of ethylene oxide, per each alkyl group. Illustrative examples of alky and aryl sulfonates are sodium tridecyl benzene sulfonate (STBS) and sodium dodecylbenzene sulfonate (SDBS).

Illustrative examples of sulfosuccinates include, but are not limited to, dimethicone copolyol sulfosuccinate, diamyl sulfosuccinate, dicapryl sulfosuccinate, dicyclohexyl sulfosuccinate, diheptyl sulfosuccinate, dihexyl sulfosuccinate, diisobutyl sulfosuccinate, dioctyl sulfosuccinate, C12-15 pareth sulfosuccinate, cetearyl sulfosuccinate, cocopolyglucose sulfosuccinate, cocoyl butyl gluceth-10 sulfosuccinate, deceth-5 sulfosuccinate, deceth-6 sulfosuccinate, dihydroxyethyl sulfosuccinylundecylenate, hydrogenated cottonseed glyceride sulfosuccinate, isodecyl sulfosuccinate, isostearyl sulfosuccinate, laneth-5 sulfosuccinate, laureth sulfosuccinate, laureth-12 sulfosuccinate, laureth-6 sulfosuccinate, laureth-9 sulfosuccinate, lauryl sulfosuccinate, nonoxynol-10 sulfosuccinate, oleth-3 sulfosuccinate, oleyl sulfosuccinate, PEG-10 laurylcitrate sulfosuccinate, sitosereth-14 sulfosuccinate, stearyl sulfosuccinate, tallow, tridecyl sulfosuccinate, ditridecyl sulfosuccinate, bisglycol ricinosulfosuccinate, di(1,3-di-methylbutyl)sulfosuccinate, and silicone copolyol sulfosuccinates.

Illustrative examples of sulfosuccinamates include, but are not limited to, lauramido-MEA sulfosuccinate, oleamido PEG-2 sulfosuccinate, cocamido MIPA-sulfosuccinate, cocamido PEG-3 sulfosuccinate, isostearamido MEA-sulfosuccinate, isostearamido MIPA-sulfosuccinate, lauramido MEA-sulfosuccinate, lauramido PEG-2 sulfosuccinate, lauramido PEG-5 sulfosuccinate, myristamido MEA-sulfosuccinate, oleamido MEA-sulfosuccinate, oleamido PIPA-sulfosuccinate, oleamido PEG-2 sulfosuccinate, palmitamido PEG-2 sulfosuccinate, palmitoleamido PEG-2 sulfosuccinate, PEG-4 cocamido MIPA-sulfosuccinate, ricinoleamido MEA-sulfosuccinate, stearamido MEA-sulfosuccinate, stearyl sulfosuccinamate, tallamido MEA-sulfosuccinate, tallow sulfosuccinamate, tallowamido MEA-sulfosuccinate, undecylenamido MEA-sulfosuccinate, undecylenamido PEG-2 sulfosuccinate, wheat germamido MEA-sulfosuccinate, and wheat germamido PEG-2 sulfosuccinate.

Some examples of commercial sulfonates are AEROSOL® OT-S, AEROSOL® OT-MSO, AEROSOL® TR70% (Cytec Inc., West Paterson, New Jersey), NaSul CA-HT3 (King Industries, Norwalk, Connecticut), and C500 (Crompton Co., West Hill, Ontario, Canada). AEROSOL® OT-S is sodium dioctyl sulfosuccinate in petroleum distillate. AEROSOL® OT-MSO also contains sodium dioctyl sulfosuccinate. AEROSOL® TR70% is sodium bistridecyl sulfosuccinate in mixture of ethanol and water. NaSul CA-HT3 is calcium dinonylnaphthalene sulfonate/carboxylate complex. C500 is an oil-soluble calcium sulfonate.

An alkyl group refers to a saturated hydrocarbon group having one or more carbon atoms, including straight-chain alkyl groups (e.g., methyl, ethyl, propyl, butyl, pentyl, hexyl, heptyl, octyl, nonyl, decyl, and so on), cyclic alkyl groups (or cycloalkyl or alicyclic or carbocyclic groups) (e.g., cyclopropyl, cyclobutyl, cyclopentyl, cyclohexyl, cycloheptyl, cyclooctyl, and so on), branched-chain alkyl groups (e.g., isopropyl, tert-butyl, sec-butyl, isobutyl, and so on), and alkyl-substituted alkyl groups (e.g., alkyl-substituted cycloalkyl groups and cycloalkyl-substituted alkyl groups).

Alkyl can be unsubstituted alkyl or substituted alkyl. Substituted alkyl refers to alkyl having one or more substituents replacing one or more hydrogen atoms on one or more carbon atoms of the hydrocarbon backbone. Such substituents can include, e.g., alkenyl, alkynyl, halogeno (halo), hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl or aromatic (including heteroaromatic) groups.

In some embodiments, substituted alkyl can include a heterocyclic group. Heterocyclic groups include closed ring structures analogous to carbocyclic groups in which one or more of the carbon atoms in the ring is an element other than carbon, for example, a heteroatom such as nitrogen, sulfur or oxygen. Heterocyclic groups can be saturated or unsaturated. Exemplary heterocyclic groups include aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran and furan.

For an anionic surfactant, the counterion is typically sodium but can alternatively be, e.g., potassium, lithium, calcium, magnesium, ammonium, amines (primary, secondary, tertiary or quandary) or other organic bases. Exemplary amines include isopropylamine, ethanolamine, diethanolamine, and triethanolamine. Mixtures of the above cations can also be used.

A surfactant used in the preparation of the present materials can be cationic. Such cationic surfactants include, but are not limited to, pyridinium-containing compounds, and primary, secondary tertiary or quaternary organic amines. For a cationic surfactant, the counterion can be, for example, chloride, bromide, methosulfate, ethosulfate, lactate, saccharinate, acetate and phosphate. Examples of cationic amines include polyethoxylated oleyl/stearyl amine, ethoxylated tallow amine, cocoalkylamine, oleylamine and tallow alkyl amine, as well as mixtures thereof.

Examples of quaternary amines with a single long alkyl group are cetyltrimethyl ammonium bromide (CTAB), benzyldodecyldimethylammonium bromide (BddaBr), benzyldimethylhexadecylammonium chloride (BdhaCl), dodecyltrimethylammonium bromide, myristyl trimethyl ammonium bromide, stearyl dimethyl benzyl ammonium chloride, oleyl dimethyl benzyl ammonium chloride, lauryl trimethyl ammonium methosulfate (also known as cocotrimonium methosulfate), cetyl-dimethyl hydroxyethyl ammonium dihydrogen phosphate, bassuamidopropylkonium chloride, cocotrimonium chloride, di stearyldimonium chloride, wheat germ-amidopropalkonium chloride, stearyl octyidimonium methosulfate, isostearaminopropal-konium chloride, dihydroxypropyl PEG-5 linoleammonium chloride, PEG-2 stearmonium chloride, behentrimonium chloride, dicetyl dimonium chloride, tallow trimonium chloride and behenamidopropyl ethyl dimonium ethosulfate.

Examples of quaternary amines with two long alkyl groups are didodecyldimethylammonium bromide (DDAB), distearyldimonium chloride, dicetyl dimonium chloride, stearyl octyldimonium methosulfate, dihydrogenated palmoylethyl hydroxyethylmonium methosulfate, dipalmitoylethyl hydroxyethylmonium methosulfate, dioleoylethyl hydroxyethylmonium methosulfate, and hydroxypropyl bisstearyldimonium chloride.

Quaternary ammonium compounds of imidazoline derivatives include, for example, isostearyl benzylimidonium chloride, cocoyl benzyl hydroxyethyl imidazolinium chloride, cocoyl hydroxyethylimidazolinium PG-chloride phosphate, and stearyl hydroxyethylimidonium chloride. Other heterocyclic quaternary ammonium compounds, such as dodecylpyridinium chloride, amprolium hydrochloride (AH), and benzethonium hydrochloride (BH) can also be used.

A surfactant used in the preparation of the present materials can be nonionic, including, but not limited to, polyalkylene oxide carboxylic acid esters, fatty acid esters, fatty alcohols, ethoxylated fatty alcohols, poloxamers, alkanolamides, alkoxylated alkanolamides, polyethylene glycol monoalkyl ether, and alkyl polysaccharides. Polyalkylene oxide carboxylic acid esters have one or two carboxylic ester moieties each with about 8 to 20 carbons and a polyalkylene oxide moiety containing about 5 to 200 alkylene oxide units. An ethoxylated fatty alcohol contains an ethylene oxide moiety containing about 5 to 150 ethylene oxide units and a fatty alcohol moiety with about 6 to about 30 carbons. The fatty alcohol moiety can be cyclic, straight, or branched, and saturated or unsaturated. Some examples of ethoxylated fatty alcohols include ethylene glycol ethers of oleth alcohol, steareth alcohol, lauryl alcohol and isocetyl alcohol. Poloxamers are ethylene oxide and propylene oxide block copolymers, having from about 15 to about 100 moles of ethylene oxide. Alkyl polysaccharide (“APS”) surfactants (e.g., alkyl polyglycosides) contain a hydrophobic group with about 6 to about 30 carbon atoms and a polysaccharide (e.g., polyglycoside) as the hydrophilic group. An example of a commercial nonionic surfactant is FOA-5 (Octel Starreon LLC., Littleton, Colorado).

Specific examples of suitable nonionic surfactants include alkanolamides such as cocamide diethanolamide (“DEA”), cocamide monoethanolamide (“MEA”), cocamide monoisopropanolamide (“MIPA”), PEG-5 cocamide MEA, lauramide DEA, and lauramide MEA; alkyl amine oxides such as lauramine oxide, cocamine oxide, cocamidopropylamine oxide, and lauramidopropylamine oxide; sorbitan laurate, sorbitan distearate, fatty acids or fatty acid esters such as lauric acid, isostearic acid, and PEG-150 distearate; fatty alcohols or ethoxylated fatty alcohols such as lauryl alcohol, alkylpolyglucosides such as decyl glucoside, lauryl glucoside, and coco glucoside.

A surfactant used in the preparation of the present materials can be zwitterionic, having both a positive charge and a negative charge on the same molecule. The positive charge group can be, e.g., quaternary ammonium, phosphonium, or sulfonium, whereas the negative charge group can be, e.g., carboxylate, sulfonate, sulfate, phosphate or phosphonate. Similar to other classes of surfactants, the hydrophobic moiety can contain one or more long, straight, cyclic, or branched, aliphatic chains of about 8 to 18 carbon atoms. Specific examples of zwitterionic surfactants include alkyl betaines such as cocodimethyl carboxymethyl betaine, lauryl dimethyl carboxymethyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl betaine, oleyl dimethyl gamma-carboxypropyl betaine, and lauryl bis-(2-hydroxypropyl)alphacarboxy-ethyl betaine, amidopropyl betaines; and alkyl sultaines such as cocodimethyl sulfopropyl betaine, stearyidimethyl sulfopropyl betaine, lauryl dimethyl sulfoethyl betaine, lauryl bis-(2-hydroxyethyl)sulfopropyl betaine, and alkylamidopropylhydroxy sultaines.

A surfactant used in the preparation of the present materials can be amphoteric. Examples of suitable amphoteric surfactants include ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates. Specific examples are cocoamphoacetate, cocoamphopropionate, cocoamphodiacetate, lauroamphoacetate, lauroamphodiacetate, lauroamphodipropionate, lauroamphodiacetate, cocoamphopropyl sulfonate, caproamphodiacetate, caproamphoacetate, caproamphodipropionate, and stearoamphoacetate.

A surfactant used in the preparation of the present materials can also be a polymer such as N-substituted polyisobutenyl succinimides and succinates, alkyl methacrylate vinyl pyrrolidinone copolymers, alkyl methacrylate-dialkylaminoethyl methacrylate copolymers, alkylmethacrylate polyethylene glycol methacrylate copolymers, polystearamides, and polyethylenimine.

A surfactant used in the preparation of the present materials can also be a polysorbate-type nonionic surfactant such as polyoxyethylene (20) sorbitan monolaurate (Polysorbate 20), polyoxyethylene (20) sorbitan monopalmitate (Polysorbate 40), polyoxyethylene (20) sorbitan monostearate (Polysorbate 60) or polyoxyethylene (20) sorbitan monooleate (Polysorbate 80).

A surfactant used in the preparation of the present materials can be an oil-based dispersant, which includes, e.g., alkylsuccinimides, succinate esters, high molecular weight amines, and Mannich bases and phosphoric acid derivatives. Some specific examples are polyisobutenyl succinimide-polyethylenepolyamine, polyisobutenyl succinic ester, polyisobutenyl hydroxybenzyl-polyethylenepolyamine, and bis-hydroxypropyl phosphorate.

The surfactant used in the preparation of the present materials can be a combination of two or more surfactants of the same or different types selected from the group consisting of anionic, cationic, nonionic, zwitterionic, amphoteric and ampholytic surfactants. Suitable examples of a combination of two or more surfactants of the same type include, but are not limited to, a mixture of two anionic surfactants, a mixture of three anionic surfactants, a mixture of four anionic surfactants, a mixture of two cationic surfactants, a mixture of three cationic surfactants, a mixture of four cationic surfactants, a mixture of two nonionic surfactants, a mixture of three nonionic surfactants, a mixture of four nonionic surfactants, a mixture of two zwitterionic surfactants, a mixture of three zwitterionic surfactants, a mixture of four zwitterionic surfactants, a mixture of two amphoteric surfactants, a mixture of three amphoteric surfactants, a mixture of four amphoteric surfactants, a mixture of two ampholytic surfactants, a mixture of three ampholytic surfactants, and a mixture of four ampholytic surfactants.

### Thin Polymeric Layer Materials

The techniques described above include the use of polymers to form a surface treatment 202 on high aspect ratio carbon elements (e.g., nanotubes) 201 in order to promote adhesion with the active material particles 300. While several suitable polymers have been described, it is understood that other polymers, including the following, may be used.

The polymer used in the preparation of the present materials can be a polymer material such as a water-processable polymer material. In some embodiments, any of the follow polymers (and combinations thereof) may be used: polyacrylic acid (PAA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), and polyvinyl pyrrolidone (PVP). Another exemplary polymer material is fluorine acrylic hybrid latex (TRD202A), available from JSR Corporation.

### Representative Embodiments

The following embodiments are presented for purposes of illustrating the disclosure.

1. An energy storage cell comprising an electrode active layer comprising:
a network of high aspect ratio carbon elements defining void spaces within the network;
a plurality of electrode active material particles disposed in the void spaces within the network and enmeshed in the network; and
a surface treatment on the surface of the high aspect ratio carbon elements which promotes adhesion between the high aspect ratio carbon elements and the active material particles.
   2. The energy storage cell of embodiment 1, wherein the high aspect ratio carbon elements comprise elements each having two major dimensions and one minor dimension, wherein the ratio of the length of each of the major dimensions is at least 10 times that of the minor dimension.
   3. The energy storage cell of embodiment 1, wherein the high aspect ratio carbon elements comprise elements each having one major dimension and two minor dimensions, wherein the ratio of the length of the major dimension is at least 10 times that of each of the minor dimensions.
   4. The energy storage cell of embodiment 1, wherein the high aspect ratio carbon elements comprise carbon nanotubes or carbon nanotube bundles.
   5. The energy storage cell of embodiment 1, wherein the high aspect ratio carbon elements comprise graphene flakes.
   6. The energy storage cell of embodiment 1, wherein the electrode active layer contains less than 10% by weight polymeric binders disposed in the void spaces.
   7. The energy storage cell of embodiment 1, wherein the electrode active layer contains less than 1% by weight polymeric binders disposed in the void spaces.
   8. The energy storage cell of embodiment 1, wherein the electrode active layer is substantially free of polymeric material other than the surface treatment.
   9. The energy storage cell of embodiment 1, wherein the electrode active layer is substantially free of polymeric material.
   10. The energy storage cell of embodiment 1, wherein the surface treatment comprises a material which is soluble in a solvent having a boiling point less than 202° C.
   11. The energy storage cell of embodiment 1, wherein the surface treatment comprises a material which is soluble in a solvent having a boiling point less than 185° C.
   12. The energy storage cell of embodiment 1, wherein during the formation of the active layer, a material forming the surface treatment was dissolved in a solvent having a boiling point less than 202° C.
   13. The energy storage cell of embodiment 1, wherein during the formation of the active layer, a material forming the surface treatment was dissolved in a solvent having a boiling point less than 185° C.
   14. The energy storage cell of embodiment 1, wherein during the formation of the active layer, a material forming the surface treatment was dissolved in a solvent comprising isopropyl alcohol.
   15. The energy storage cell of embodiment 1, wherein during the formation of the active layer, a material forming the surface treatment was dissolved in a solvent substantially free of pyrrolidone compounds.
   16. The energy storage cell of embodiment 1, wherein the active material particles comprise lithium metal oxides.
   17. The energy storage cell of embodiment 16, wherein the lithium metal oxide is a lithium cobalt oxide, a lithium nickel manganese cobalt oxide, a lithium manganese oxide, a lithium nickel cobalt aluminum oxide a lithium titanate oxide, or a lithium iron phosphate oxide.
   18. The energy storage cell of embodiment 17, wherein the lithium cobalt oxide is LiCoO₂, the lithium nickel manganese cobalt oxide is LiNiMnCo; the lithium manganese oxide is LiMn₂O₄ or Li₂MnO₃, the lithium nickel cobalt aluminum oxide is LiNiCoAlO₂, the lithium titanate oxide is Li₄Ti₅O₁₂, and the lithium iron phosphate oxide is LiFePO₄.
   19. The energy storage cell of embodiment 18, wherein the LiNiMnCo is LiNiₓMn_{y}Co_{1-x-y}, where x is equal to or greater than about 0.7 and wherein y is about 0.1.
   20. The energy storage cell of embodiment 18, wherein the LiNiMnCo is LiNi_{0.33}Mn_{0.33}Co_{0.33}O₂, LiNi_{0.5}Mn_{0.3}Co_{0.2}O₂, or LiNi_{0.6}Mn_{0.2}Co_{0.2}O₂.
   21. The energy storage cell of embodiment 1, wherein the network is at least ninety nine percent carbon by weight and exhibits electrical connectivity above a percolation threshold, wherein the network defines one or more highly electrically conductive pathways having a length greater than 100 μm.
   22. The energy storage cell of embodiment 1, wherein the surface treatment comprises a surfactant that forms a surfactant layer that is bonded to the carbon elements and comprises a plurality of surfactant elements each having a hydrophobic end and a hydrophilic end, wherein the hydrophobic end is disposed proximal to a surface of the carbon elements and the hydrophilic end is disposed distal to said surface of the carbon elements.
   23. The energy storage cell of embodiment 22, wherein the surfactant is an ionic surfactant compound that comprises at least one selected from the group consisting of hexadecyltrimethylammonium tetrafluoroborate, hexadecyltrimethylammonium tetrafluoroborate, N-(cocoalkyl)-N,N,N-trimethylammonium methyl sulfate, cocamidopropyl betaine hexadecyltrimethylammonium acetate, and hexadecyltrimethylammonium nitrate.
   24. The energy storage cell of embodiment 22, wherein the surfactant provides functional groups which promote adhesion of the active material particles to the network.
   25. An energy storage device comprising an electrode comprising:
an active layer comprising an active material and a nanocarbon, wherein the active layer is substantially free of polyvinylidene fluoride/difluoride (PVDF) and N-methyl-2-pyrrolidone (NMP); and
a current collector.
   26. The energy storage device of embodiment 25, wherein the nanocarbon has a high aspect ratio.
   27. The energy storage device of embodiment 25 or 26, wherein the nanocarbon is selected from carbon nanotubes, graphene (e.g., graphene flakes), oxidized graphene, exfoliated graphite nano-platelets, carbon nanoparticles, carbon powder, activated carbon, carbon black, carbon nanofibers, carbon nanohorns, carbon nano-onions, fullerene, carbon aerogels, and any combinations thereof.
   28. The energy storage device of embodiment 27, wherein the nanocarbon comprises carbon nanotubes (CNTs), such as single-wall CNTs, double-wall CNTs or multi-wall CNTs, or any combination thereof.
   29. The energy storage device of any one of embodiments 25 to 28, wherein the nanocarbon has a surface treatment.
   30. The energy storage device of embodiment 29, wherein the surface treatment enhances adhesion of the nanocarbon to the active material and adhesion of the active layer to the current collector.
   31. The energy storage device of any one of embodiments 25 to 30, wherein the active layer further comprises a polymer additive, a polymer or a surfactant, or any combination thereof.
   32. The energy storage device of embodiment 31, wherein the polymer additive, the polymer or the surfactant, or any combination thereof, provides surface treatment to the nanocarbon.
   33. The energy storage device of any one of embodiments 25 to 32, wherein the electrode is a cathode.
   34. The energy storage device of embodiment 33, wherein the active material comprises lithium iron phosphate or a lithium metal oxide, such as a lithium cobalt oxide, a lithium manganese oxide, a lithium nickel manganese oxide, a lithium nickel manganese cobalt oxide, a lithium nickel cobalt aluminum oxide or a lithium titanate oxide, or any combination thereof.
   35. The energy storage device of embodiment 34, wherein the active material comprises a nickel-rich lithium nickel manganese cobalt oxide, such as NMC721, NMC811 or NMC91.
   36. The energy storage device of any one of embodiments 33 to 35, wherein the active layer of the cathode comprises by weight about 90-99% of a nickel-rich lithium nickel manganese cobalt oxide; about 0.5-5% of the nanocarbon; and about 0.5-5% of a polymer additive, a polymer or a surfactant, or any combination thereof.
   37. The energy storage device of any one of embodiments 33 to 36, wherein the current collector comprises an aluminum foil.
   38. The energy storage device of any one of embodiments 25 to 37, wherein the electrode is an anode.
   39. The energy storage device of embodiment 38, wherein the active material comprises silicon, a silicon oxide, a silicon composite material (e.g., a silicon/graphite composite material) or graphite, or any combination thereof.
   40. The energy storage device of embodiment 39, wherein the active material comprises silicon as the dominant element by weight.
   41. The energy storage device of any one of embodiments 38-40, wherein the active layer of the anode comprises by weight about 60-90% of silicon or/and a silicon composite material (e.g., a silicon/graphite composite material); about 5-20% of graphite; about 1-5% of the nanocarbon; and about 5-20% of a polymer additive, a polymer or a surfactant, or any combination thereof.
   42. The energy storage device of any one of embodiments 38-41, wherein the current collector comprises a copper foil.
   43. The energy storage device of any one of embodiments 25 to 42, further comprising an electrolyte comprising one or more salts and one or more organic solvents.
   44. The energy storage device of embodiment 43, wherein the electrolyte comprises one or more lithium salts such as LiPF₆ or/and lithium bis(fluorosulfonyl)imide (LiFSI), and one or more carbonate solvents such as one or more linear carbonate solvents selected from dimethyl carbonate (DMC), diethyl carbonate (DEC) and ethyl methyl carbonate (EMC).
   45. The energy storage device of embodiment 43 or 44, wherein the electrolyte further comprises one or more additives, such as one or more cyclic carbonates selected from ethylene carbonate (EC), fluoroethylene carbonate (FEC), vinylethylene carbonate (VEC), vinylene carbonate (VC) and propylene carbonate (PC).
   46. The energy storage device of any one of embodiments 25 to 45, which:
(a) has a specific energy of at least about 330 Wh/kg;
(b) has a gravimetric energy density of at least about 330 Wh/kg;
(c) has a volumetric energy density of at least about 850 Wh/L;
(d) has a capacity of at least about 50 Ah;
(e) has an internal resistance of no more than about 40 mΩ;
(f) charges to 80% stage of charge within about 15 minutes;
(g) has an operating voltage range of at least about 4.0-2.5 V; or
(h) has a cycle life of at least about 750 charge/discharge cycles; or
(i) any combination or all of the above.
   47. The energy storage device of any one of embodiments 25 to 46, which is a battery cell or a battery.

### EXAMPLES

The following non-limiting examples further describe the application of the teachings of this disclosure. In some embodiments of the following examples, the term “binder-free” or “binderless” electrode refers to an electrode of the type described in detail above and featuring a 3D matrix or scaffold of high aspect ratio carbon elements (e.g., nanotubes) with a surface treatment thereon which promotes adhesion of active material to the matrix or scaffold without the need for a bulk polymeric binder such as PVDF.

As used in the following examples, the term C-rate refers to a measure of the rate at which a battery is discharged relative to its maximum capacity. A 1 C rate means that the discharge current will discharge the entire battery in 1 hour. For a battery with a capacity of 100 Amp-hrs, this equates to a discharge current of 100 Amps.

### Example 1. Electric Vehicle Battery Cell

The following battery cell is suitable for use in electric vehicles (“EV”). This cell combines cathode and anode technology of the type described herein for use, e.g., in an EV application. Key high-level benefits include lower cost to manufacture, higher energy density, excellent power density, and wide temperature range operation. These benefits are derived from the present process for manufacturing battery electrodes, which eliminates the use of PVDF polymer binder and toxic solvents like N-methyl-2-pyrrolidone (NMP). The result is a substantial performance advantage in range, charging speed, and acceleration for the end user, and a manufacturing process that is less expensive, less capital-intensive and safer for the battery producers.

The teachings herein provide a technology platform to manufacture electrodes for energy storage which may exhibit the following advantages: reduction in cost of manufacturing and in the $/kWh of resulting LIB s, increase in energy density by combining cathodes with thick coatings and high-capacity anodes featuring high-performance active materials such as Si or SiOx, and fast charging. The teachings herein provide a scalable technology to improve power density in energy storage, by removing conventional polymer binders from the active material coatings or layers.

Conventional electrodes for LiBs are fabricated by mixing an active material, conductive additives and a polymer binder in a slurry. Conventional cathodes are manufactured using NMP-based slurries and PVDF polymer binders. Those binders have very high molecular weight and promote cohesion of active material particles and adhesion to the current collector foil via two main mechanisms: 1) the entanglement promoted by long polymer chains, and 2) hydrogen bonds between the polymer, the active material, and the current collector. However, the polymer binder-based method presents significant drawbacks in performance, power density, energy density, and manufacturing cost.

The teachings herein provide electrodes that do not have PVDF binders in cathodes, or other conventional binders in anodes. Instead, as detailed above a 3D carbon scaffold or matrix holds active material particles together to form a cohesive layer that is also strongly attached to the metallic current collector. Such active material structure is created during slurry preparation and subsequently in a roll to roll (“R2R”) coating and drying process. One of the main advantages of this technology is its scalability and “drop-in” nature since it compatible with conventional electrode manufacturing processes.

The 3D carbon matrix is formed during a slurry preparation using the techniques described herein: high aspect ratio carbon materials (e.g., nanotubes) are properly dispersed and chemically functionalized using, e.g., a 2-step slurry preparation process (such as the type described above with reference to FIG. 6). The chemical functionalization is designed to form an organized self-assembled structure with the surface of active material particles, e.g., NMC particles for use in a cathode or silicon (“Si”) particles or silicon oxide (“SiOx”) particles in the case of an anode. The so formed slurry may be based on alcohol solvent(s) for cathodes and water for anodes, and such solvents are very easily evaporated and handled during the manufacturing process. Electrostatic interactions promote the self-organized structure in the slurry, and after the drying process the bonding between the so formed carbon matrix with active material particles and the surface of the current collector is promoted by the surface treatment (e.g., functional groups on the matrix) as well as the strong entanglement of the active material in the carbon matrix.

As will be understood by one skilled in the art, the mechanical properties of the electrodes can be readily modified depending on the application, and the mass loading requirements by tuning the surface functionalization vs. entanglement effect.

After coating and drying, the electrodes undergo a calendering step to control the density and porosity of the active material. In NMC cathode electrodes, densities of about 3.5 g/cc or more and about 20% porosity or more can be achieved. Depending on mass loading and LIB cell requirements, the porosity can be optimized. As for SiOx/Si anodes, the porosity is specifically controlled to accommodate active material expansion during the lithiation process.

In some typical applications, the teachings herein may provide a reduction in $/kWh of up to about 20%. By using advantageous solvents that are easily evaporated, the electrode throughput is higher, and more importantly, the energy consumption from the long driers is significantly reduced. The solvent recovery systems are also much simplified when alcohol or other solvent mixtures are used in lieu of NMP.

The teachings herein provide a 3D carbon matrix that dramatically boosts electrode conductivity by a factor of about 10× to about 100× compared to electrodes using conventional binders such as PVDF, which enables fast charging at a battery level. Thick electrode coatings in the cathode up to about 150 μm (or more) per side of current collector are possible with this technology. The solvent(s) used in the slurry in combination with a strong 3D carbon matrix are designed to achieve thick wet coatings without cracking during the drying step. Thick cathodes with high-capacity anodes enable a substantial jump in energy density reaching about 400 Wh/kg or more.

Fast charging is achieved by combining high-capacity anodes that are lithiated through an alloying process (e.g., Si/SiOx) and by reducing the overall impedance of the cell when combining anodes and cathodes as described herein. The teachings herein provide fast charging by having highly conductive electrodes, and in particular highly conductive cathode electrodes.

One exemplary embodiment includes a Li-ion battery energy storage device in a pouch cell format that combines Ni-rich NMC active material in the cathodes and SiOx and graphite blend active material in the anodes, where both anodes and cathodes are made using a 3D carbon matrix process as described herein.

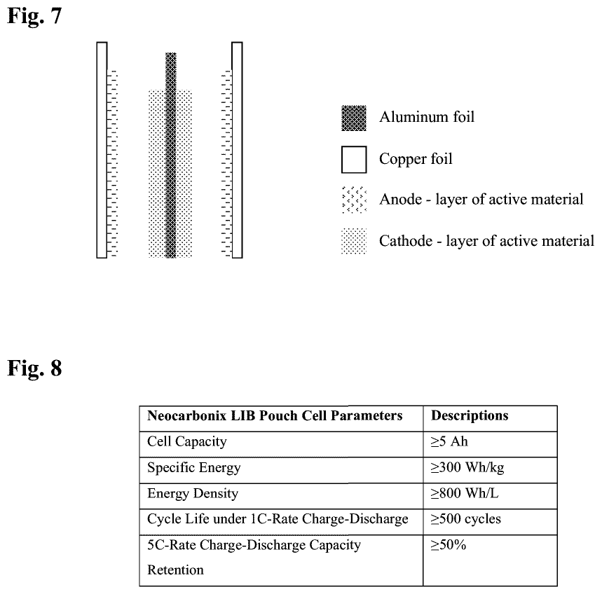

A schematic of an electrode arrangement pouch cell device is shown in FIG. 7. As shown, a double-sided cathode using polymer binder-free cathode active layers on opposing sides of an aluminum foil current collector are disposed between two single-sided anodes each having a polymer binder-free anode active layer disposed on a copper foil current collector. The electrodes are separated by a permeable separator material (not shown) and wetted with an electrolyte (not shown). The arrangement can be housed in a pouch cell of the type well known in the art.

These devices may feature high mass loading of Ni-rich NMC cathode electrodes and their manufacturing method: mass loading=20-30 mg/cm², specific capacity>210 mAh/g. SiOx/Graphite anode (SiOx content=˜20 wt. %) based electrodes and their material synthesis and manufacturing method: mass loading 8-14 mg/cm², reversible specific capacity ≥550 mAh/g. Long life performance specially for SiOx/Graphite anode based Li-ion based electrolyte for battery: from −30 to 60° C. High-energy, high-power density, and long cycle life Ni-rich NMC cathode/SiOx+Graphite/Carbon+based Li-ion battery pouch cells: capacity≥5 Ah, Specific Energy≥300 Wh/kg, Energy Density ≥800 Wh/L, with a cycle life of more than 500 cycles under 1 C-Rate charge-discharge, and ultra-high-power fast charge-discharge C-Rate (Up to 5 C-Rate) capabilities. A summary of performance parameters for a pouch cell of this type are summarized in FIG. 8.

### Example 2. Comparative Performance NMC811 Lithium Ion Battery

As detailed above, the teachings herein provide electrodes configured with an advanced 3-D high aspect ratio carbon binding structure that eliminates the need for polymer binders, providing greater power, energy density (e.g., via thicker electrodes and higher mass loading of active material), and performance in extreme environments compared to traditional battery electrode designs. The high-performance Li-ion battery energy storage devices are designed and manufactured with an optimized capacity ratio design of binder-free cathode/anode electrodes, anode electrode pre-lithiation, and wide operating temperature electrolyte (e.g., −30 to 60° C.), and optimized test formation processes.

As described herein, the electrodes are manufactured by completely removing high molecular weight polymers such as PVDF and the toxic NMP solvent from the active material layer. This dramatically improves LiB performance while decreasing the cost of manufacturing and the capital expenditures related to mixing, coating and drying, NMP solvent recovery, and calendering. In embodiments of the electrodes, a 3D nanoscopic carbon matrix acts as a mechanical scaffold for the electrode active material and mimics the polymer chain entanglement. Covalent or non-covalent bonds are also present between the surface of the high aspect ratio carbon elements (e.g., nanotubes), the active materials, and the current collector, which promotes adhesion and cohesion. As opposed to polymers, however, the 3D nanoscopic carbon matrix is very electrically conductive, which enables very high power (high C-rates). This scaffold structure is also more suitable for producing thick electrode active material, which is a powerful way to increase the energy density of LiB cells.

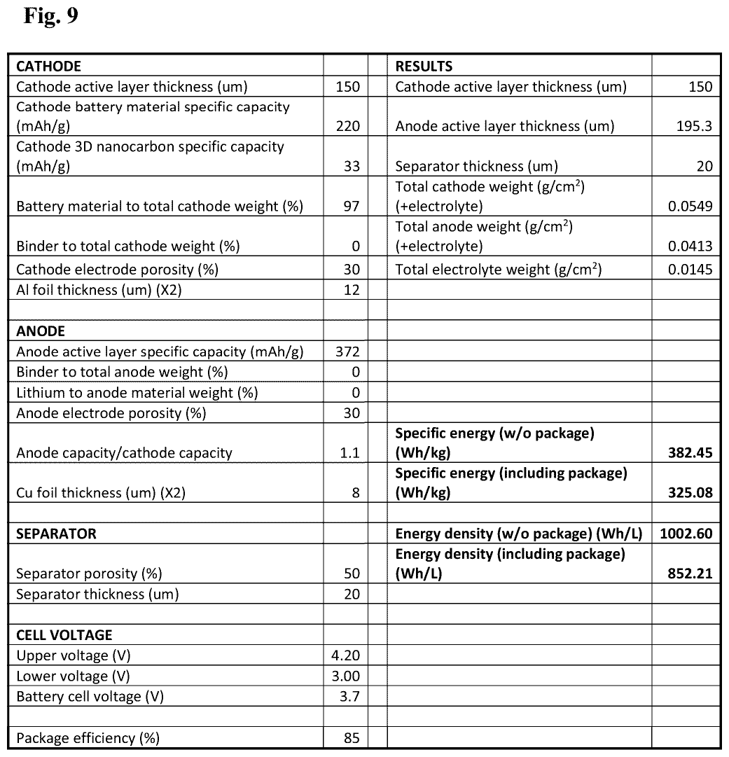

In the present example, a binder-free cathode was produced according to the teachings of this disclosure featuring NMC811 as an active material and incorporated in a Li-ion battery (LIB). The cell featured a graphite anode of the conventional type known in the art. The cell was constructed as described above with reference to FIG. 7 using the parameters summarized in FIG. 9. A conventional electrolyte was used, which composed of 1M LiPF₆ in a solvent mixture of ethylene carbonate and dimethyl carbonate with 1% by weight vinyl carbonate additive. As a comparison, an otherwise identical cell was produced using a PVDF binder-based cathode. The performance of the cells was compared as described below, showing clear advantages for the binder-free cathode cell.

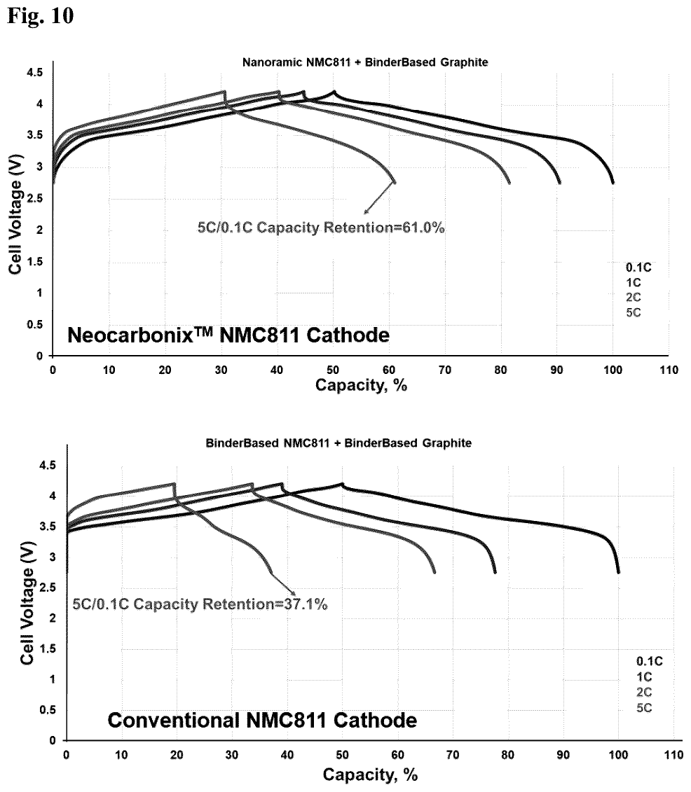

As seen in the results shown in FIG. 10, the binder-free cell can reach a specific energy as high as 320 Wh/kg based on a 20 Ah battery cell design and a graphite anode with a cycle life of more than 2,000 cycles under 2 C-rate charge/discharge. In comparison, the conventional binder-based cathode cell can only achieve 100-250 Wh/kg in specific energy at the cell level.

The binder-free cathode cell exhibits ultra-high power, fast charge/discharge C-rate, up to 5 C-rate with >50% capacity retention. FIG. 10 shows a comparison of the charge/discharge curves at various C-rates for the binder-free cathode cell (top) and the conventional binder-based cathode cell (bottom). The binder-free cathode cell charge/discharge curve shows over 60% capacity retention of a combined charge/discharge at a 5 C rate. Accordingly, separate discharge or charge would exhibit even higher capacity retention. In the described example, a conventional graphite anode is used. Initial experimental results show that when a Si-dominant anode is combined with NMC811 cathode used in the present example, 10 C charge rate is achievable.

FIG. 11 shows a comparison of the cycle life of the above-described cells. The cells were repetitively cycled between voltages of 2.75 V and 4.2 V at 25° C., and the discharge capacity was recorded. The binder-free cathode cell exhibits a lifetime of greater than 2,000 cycles with discharge-capacity loss of less than 20%. In contrast, the binder-based cathode cell experiences greater than 20% discharge-capacity loss after only about 1,000 cycles.

### Example 3. Pouch Half Cell Comparison

Binder-free cathode electrodes of the type described herein can advantageously achieve high mass loadings. For example, a mass loading of about 45 mg/cm² per side of NMC811 active material is possible. The present example sets forth experimental results showing the performance of such a high mass loading binder-free electrode in comparison with a control electrode featuring PVDF binder and an NMC811 active material.

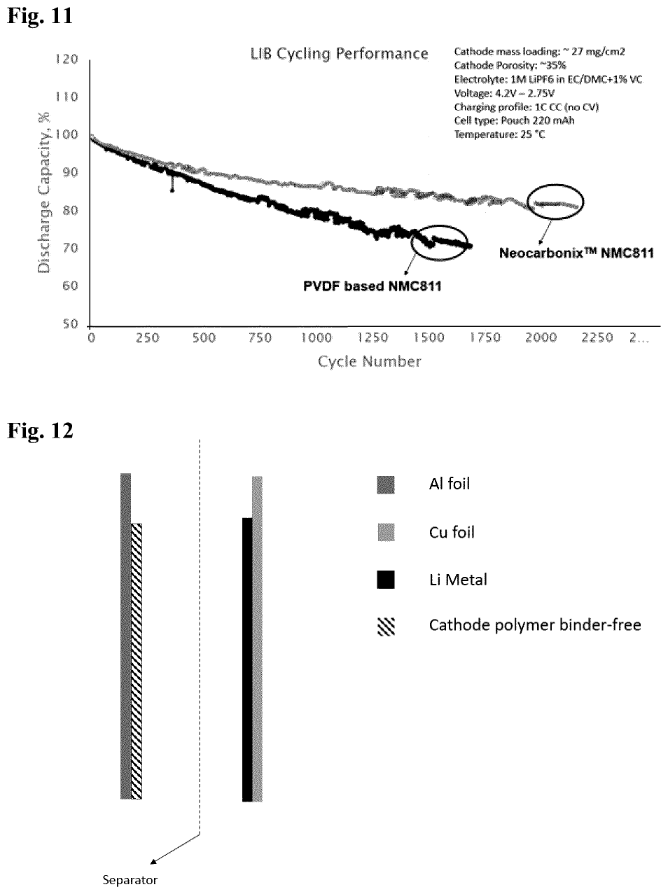

To perform the comparison, half cells of the type shown in FIG. 12 were constructed using a one-sided cathode (either binder-free or the binder-based control) and a lithium foil on a copper substrate as the counter electrode for the cell. The half cells underwent charge rate testing under various current densities, and the results are summarized below.

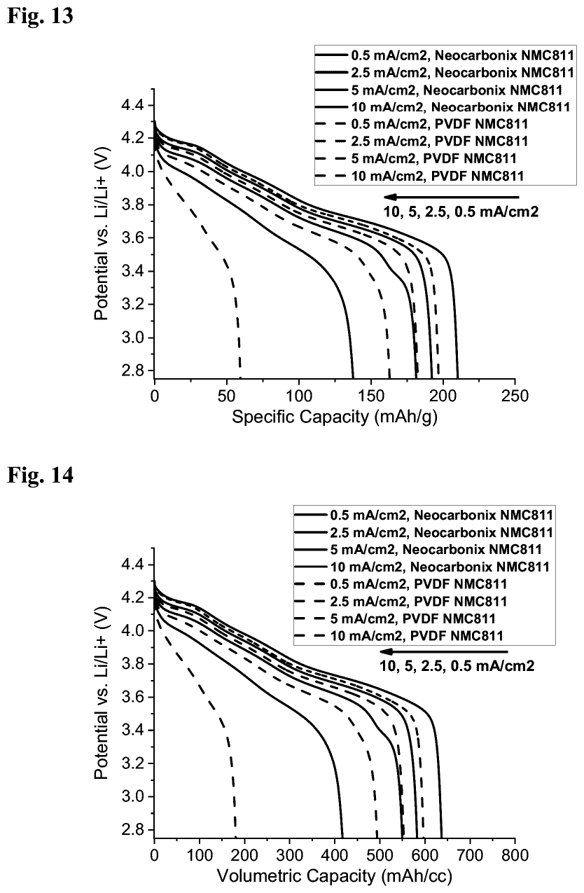

FIG. 13 is a plot showing potential (referenced to the Li/Li+ potential) vs specific capacity for the binder-free cathode half cell (solid traces) and the reference binder-based cathode half cell (dashed traces) at various current densities. At all current densities (and thus at all C-rates), the binder-free cathode half cell shows better performance (as indicated by the relative rightward shift of the traces).

FIG. 14 is a plot showing potential (referenced to the Li/Li+ potential) vs volumetric capacity for the binder-free cathode half cell (solid traces) and the reference binder-based cathode half cell (dashed traces) at various current densities. At all current densities (and thus at all C-rates), the binder-free cathode half cell shows better performance (as indicated by the relative rightward shift of the traces).

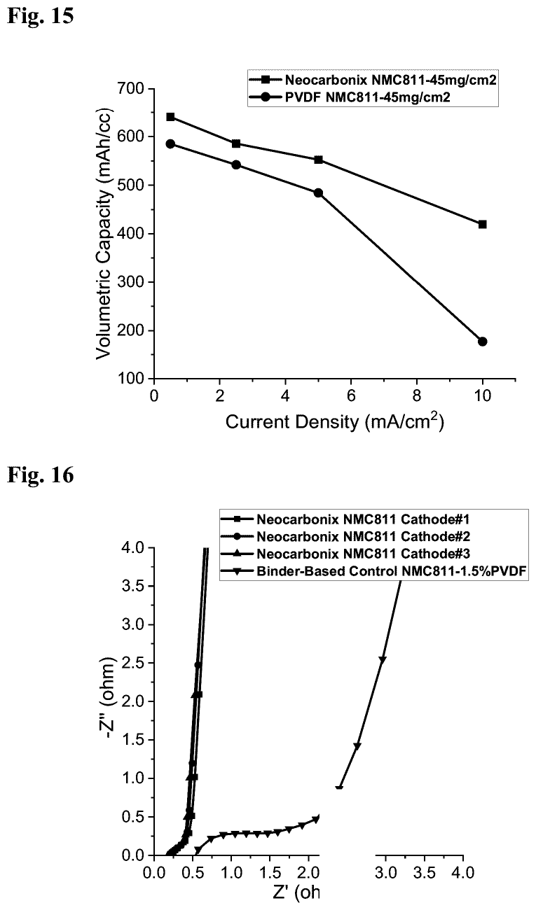

FIG. 15 shows a plot of volumetric capacity vs current density for the binder-free cathode half cell (upper trace) and the reference binder-based cathode half cell (lower trace). At all current densities (and thus at all C-rates), the binder-free cathode half cell shows better performance, with the relative performance gap widening at higher C-rates.

FIG. 16 shows a Nyquist plot resulting from electrochemical impedance spectroscopy for three binder-free cathode half cells (square, circle and triangle pointing up) and a reference binder-based cathode half cell. The binder-free cathode half cells exhibit significantly better performance than the reference half cell.

It can be seen from the figures that when the current density increases from 0.5 to 10 mA/cm² (1.2 C-rate), the discharge-capacity retention for binder-free NMC811 electrode has a much higher value compared with a PVDF binder-based control NMC811 electrode, even though both electrodes have the same mass loading of 45 mg/cm². The C-rate test under various current densities is presented as a relative comparison between conventional PVDF binder-based cathodes and binder-free cathodes, and does not reflect the absolute C-rate performance in a full cell configuration, e.g., as presented in Examples 1 and 2 above.

### Example 4. Battery Cells with PVDF-Free/NMP-Free Electrodes

In some embodiments, a battery cell comprises a PVDF-free/NMP-free, nickel-dominant or nickel-rich NMC cathode, or a plurality of the cathode. Nickel-dominant and nickel-rich NMCs are described above. In certain embodiments, the cathode, such as the active layer of the cathode, comprises about 98.75% NCM91, about 0.5% nanocarbon(s), and about 0.75% polymer additive(s) by weight/mass. The term “NCM91” is used interchangeably with the term “NMC91”. NCM91 contains about 91% nickel. In certain embodiments, the cathode active layer comprises about 0.5% carbon nanotubes (CNTs) by weight/mass. The CNTs can form a network of CNTs and electrically conductive paths in and through/across the active layer. The network of CNTs entangles or enmeshes the metal oxide particles and thereby enhances cohesion within the active layer and structural integrity of the active layer. The polymer additive(s) can act as a binder, or/and can provide surface treatment of the nanocarbon(s) (e.g., CNTs) as described above, which improves adhesion of the materials of the active layer to each other and adhesion of the active layer to the current collector and thus eliminates the need for an adhesion layer between the active layer and the current collector. In some embodiments, the cathode comprises a current collector (which may also be called a conductive layer) comprising one or more layers of aluminum (Al) foil. In certain embodiments, the thickness of each layer of aluminum foil, or the total thickness of the layer(s) of aluminum foil, is about 8-15 μm or about 10-12 μm.

In some embodiments, the battery cell comprises a silicon-dominant or silicon-rich anode, or a plurality of the anode. In some embodiments, the active layer of a silicon-dominant anode contains more than 50% silicon by weight/mass, and the active layer of a silicon-rich anode contains at least about 70%, 75%, 80%, 85% or 90% silicon by weight/mass. In certain embodiments, the anode, such as the active layer of the anode, comprises about 80% Si—C(a silicon/carbon composite material such as a silicon/graphite composite), about 7% graphite, about 3% nanocarbon(s), and about 10% polymer(s) by weight/mass. In certain embodiments, the anode active layer comprises about 3% CNTs by weight/mass. The CNTs can form a network of CNTs and electrically conductive paths in and through/across the active layer. The polymer(s) can act as a binder, or/and can provide surface treatment of the nanocarbon(s) (e.g., CNTs) as described above, which improves adhesion of the materials of the active layer to each other and adhesion of the active layer to the current collector and thus eliminates the need for an adhesion layer between the active layer and the current collector. In some embodiments, the anode comprises a current collector comprising one or more layers of copper (Cu) foil. In certain embodiments, the thickness of each layer of copper foil, or the total thickness of the layer(s) of copper foil, is about 4-10 μm or about 6-8 μm.

Examples of nanocarbon(s) that can compose a cathode or anode, such as the active layer thereof, include without limitation carbon nanotubes (including single-wall CNTs, double-wall CNTs and multi-wall CNTs), graphene (e.g., graphene flakes), oxidized graphene, exfoliated graphite nano-platelets, carbon nanoparticles, carbon powder, activated carbon, carbon black, carbon nanofibers, carbon nanohorns, carbon nano-onions, fullerene, carbon aerogels, and any combinations thereof. In some embodiments, the nanocarbon(s) comprise high aspect ratio nanocarbon(s). In certain embodiments, the nanocarbon(s) comprise carbon nanotubes, whether single-, double- or/and multi-wall CNTs.

Non-limiting examples of polymer additive(s) that can compose a cathode or anode, such as the active layer thereof, include polyacrylic acid, poly(vinyl alcohol), poly(vinyl acetate), polyacrylonitrile, polyisoprene, polyaniline, polyethylene, polyimide, polystyrene, polyurethane, polyvinyl butyral, and polyvinyl pyrrolidone, and any combinations thereof.

Non-limiting examples of polymer(s) that can compose a cathode or anode, such as the active layer thereof, include polyacrylic acid, poly(vinyl alcohol), poly(vinyl acetate), polyacrylonitrile, polyisoprene, polyaniline, polyethylene, polyimide, polystyrene, polyurethane, polyvinyl butyral, polyvinyl pyrrolidone, fluorine acrylic hybrid latex (TRD202A, JSR Corporation), and any combinations thereof.

The battery cell comprises an ion-permeable separator that physically separates the cathode and the anode to prevent a short-circuit. In some embodiments, the separator comprises one or more polymers or/and one or more ceramics. Non-limiting examples of polymer(s) that can compose a separator include polyethylene (PE), polypropylene (PP), polytetrafluoroethylene (PTFE), polyamides, polyether ether ketones (PEEKs), and any combination thereof, and examples of such ceramic(s) include Al₂O₃ or/and SiO₂ In some embodiments, the separator is a microporous, ceramic-coated polyolefin membrane. In certain embodiments, the separator comprises a membrane composed of PE or/and PP, and a ceramic coating on one side or both sides of the membrane. In certain embodiments, the membrane composed of PE or/and PP has a thickness of about 9 μm, and the ceramic coating on one side or both sides of the membrane has a thickness of about 3 μm.

The battery cell further comprises an electrolyte that fills void spaces in the electrodes and between the electrodes and the separator. The electrolyte can comprise one or more ionic liquids, one or more salts, or one or more organic solvents, or any combination or all thereof. WO 2013/126915 A1 and the counterpart US 2014/0042988 A1, both of which are incorporated herein by reference in their entirety, disclose exemplary electrolytes. In some embodiments, the electrolyte comprises one or two salts (e.g., one or two lithium salts such as one or two selected from LiPF₆, LiPO₂F₂ and lithium bis(fluorosulfonyl)imide [LiFSI]) and one or two organic solvents {e.g., one or two carbonate solvents such as one or two selected from cyclic carbonates (e.g., ethylene carbonate [EC], fluoroethylene carbonate [FEC], vinylethylene carbonate [VEC], vinylene carbonate [VC] and propylene carbonate [PC]) and linear carbonates (e.g., dimethyl carbonate [DMC], diethyl carbonate [DEC] and ethyl methyl carbonate [EMC])}. In further embodiments, the electrolyte comprises one or two carbonate solvents (e.g., one or two linear carbonates) as solvent(s) and one or two different carbonate solvents (e.g., one or two cyclic carbonates) as additive(s). In certain embodiments, the electrolyte comprises LiFSI and LiPF₆ as lithium salts, one or two carbonate solvents (e.g., one or two linear carbonates selected from DMC, DEC and EMC) as solvent(s), and one or two different carbonate solvents (e.g., one or two cyclic carbonates such as one or two selected from FEC, VEC and VC) as additive(s), and optionally one or two additional additives (e.g., an organosilicon-2 additive, a cyclic sulfate-2 additive or a nitrile-based additive, or any combination thereof). The additive(s) can enhance the electrochemical performance and properties of the electrode(s) such as the cathode. In certain embodiments, the concentration of the LiFSI/LiPF₆ lithium salt blend in the electrolyte is about 1-1.5 M, or about 1.2 M.

Table 1 lists electrochemical performance and property values for a battery cell comprising an NCM91 cathode and a silicon-dominant anode in the form of a pouch cell. In an initial capacity and energy density check, the battery cell exhibited a discharge capacity ≥4.5 Ah, a specific energy ≥330 Wh/kg, and an energy density ≥880 Wh/L at beginning of life and 25° C. based on total measured weight and total volume. In addition to the excellent electrochemical performance and properties, the battery cell achieves a cost reduction in $/kWh of about 15% compared to conventional battery cells based in part on higher energy density and lower cost for manufacturing an NMP-free electrode.

TABLE 1

| C/10 Discharge Capacity at 25° C. | 4.78 | Ah |
|---|---|---|
| C/10 Discharge Energy at 25° C. | 16.46 | Wh |
| C/3 Discharge Capacity at 25° C. | 4.63 | Ah |
| C/3 Discharge Energy at 25° C. | 15.88 | Wh |
| C/10 Specific Energy at 25° C. | 338 | Wh/kg |
| C/10 Core Energy Density at 25° C. | 939 | Wh/L |
| C/10 Energy Density at 25° C. (Total Volume) | 918 | Wh/L |
| C/3 Specific Energy at 25° C. | 326 | Wh/kg |
| C/3 Core Energy Density at 25° C. | 906 | Wh/L |
| C/3 Energy Density at 25° C. (Total Volume) | 886 | Wh/L |
| Volumetric Energy Density at 0.33 C, 25° C. | 848 | Wh/L |
| and 100% depth of discharge (DOD) | | |
| Gravimetric Energy Density at 0.33 C, 25° C. | 330 | Wh/kg |
| and 100% DOD | | |
| Capacity at 0.33 C and 25° C. | 50 | Ah |
| Loading | 5.8 | mAh/cm² |
| Alternating Current Resistance (ACR) at 1 kHz | 6.8 | mΩ |
| Direct Current Internal Resistance (DCIR) at | 39 | mΩ |
| 50% state of charge (SOC) and 25° C. | | |
| Charge Time to 80% SOC under 3.5 C Rate and | 15 | min |
| CCCV at 25° C. | | |
| 0.33 C Cycle Life based on Electric Vehicle (EV) | ≥750 charge/ | |
| Dynamic Stress Test (DST) Application, at 25° C. | discharge cycles | |
| Operating Voltage Range | 4.2-2.5 | V |

| | |
|---|---|
| Operating Temperature Range | −30° C. to 55° C. |

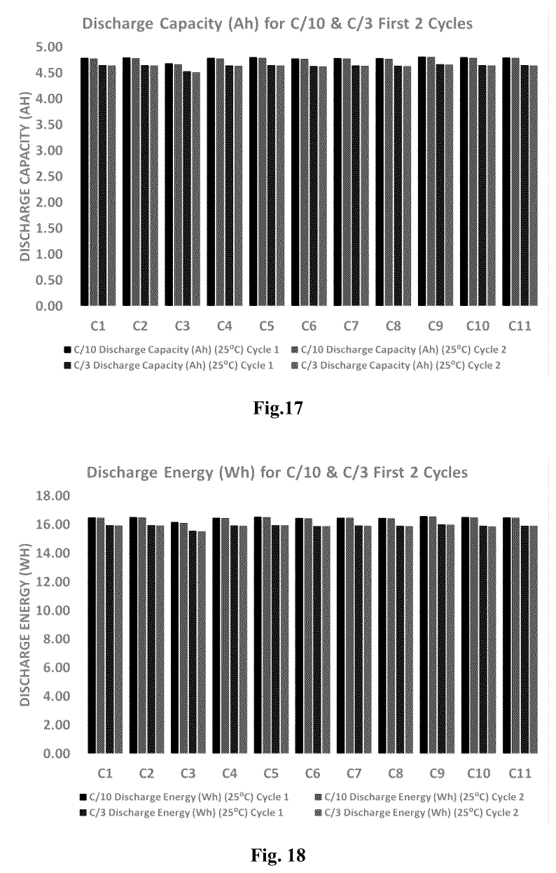

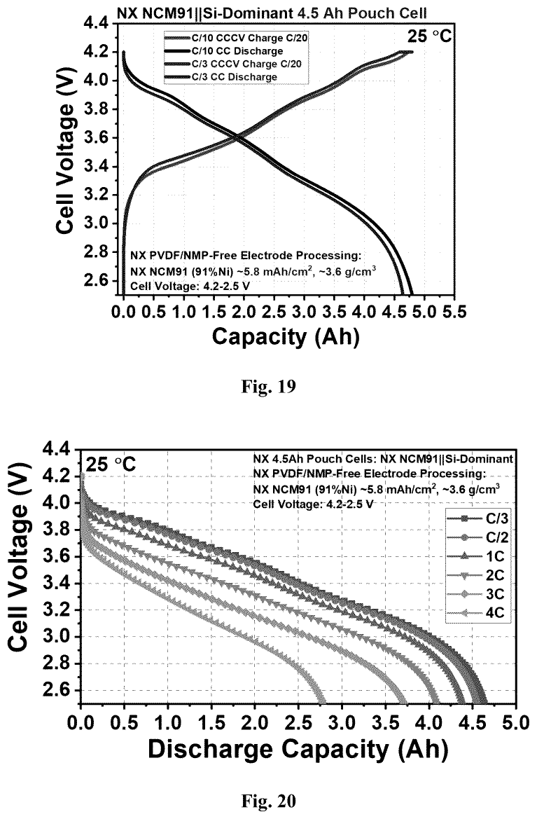

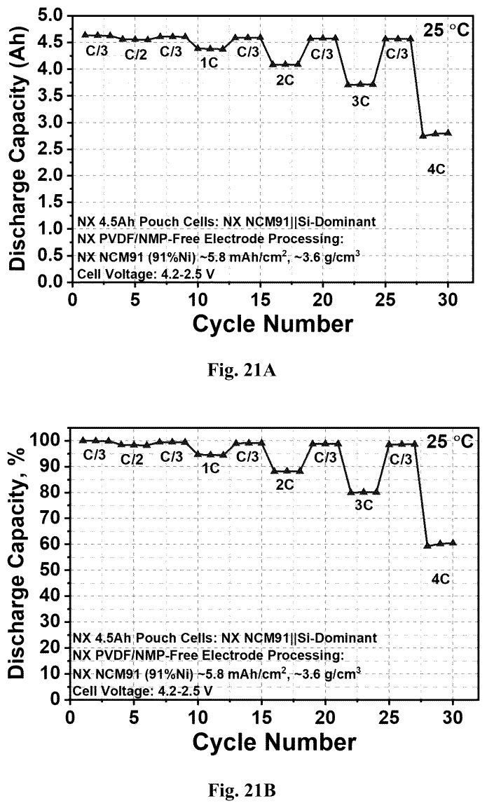

For the NCM91 cathode/silicon-dominant anode battery cell, FIG. 17 shows the discharge capacity (Ah), and FIG. 18 shows the discharge energy (Wh), for C/10 and C/3 cycles 1 and 2 at 25° C. FIG. 19 shows initial C/10 and C/3 charge/discharge curves at 25° C. In FIG. 19, “CCCV” denotes constant current-constant voltage and “CC” denotes constant current. FIG. 20 shows various discharge C-rate curves at 25° C. All the discharge C/3, C/2, 1 C, 2 C, 3 C and 4 C rate curves show a stable trend. The discharge 4 C-rate capacity and retention to the first three cycles of the C/3-rate discharge is about 60% even with an electrode having a high loading ≥5.8 mAh/cm². FIGS. 21A and B show the results of a discharge C-rate cycling test at 25° C. The test shows a stable trend for all the discharge C/3, C/2, 1 C, 2 C, 3 C and 4 C rates.

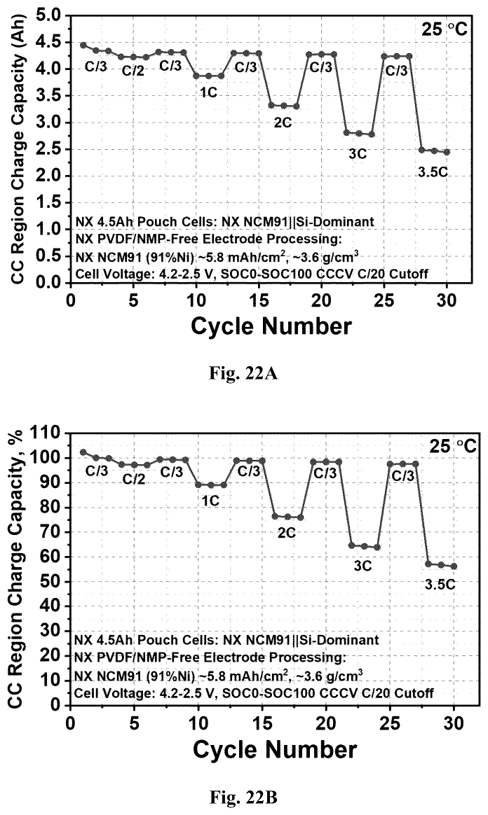

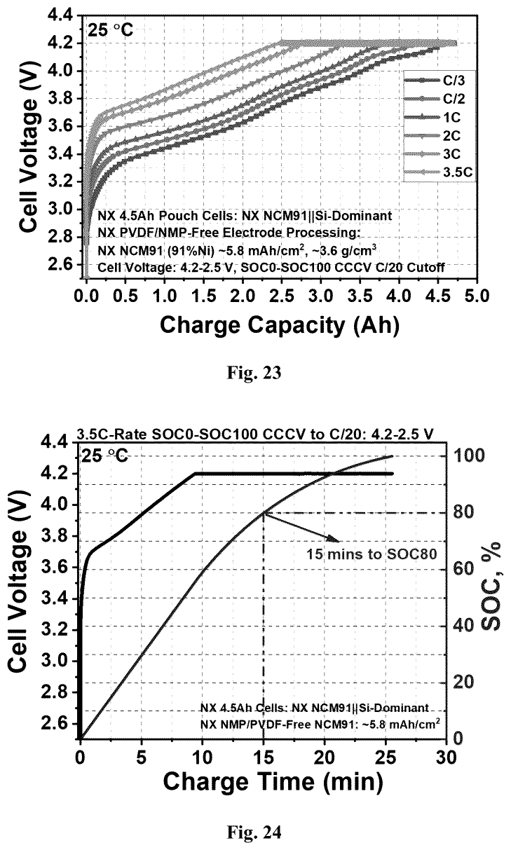

For the NCM91 cathode/silicon-dominant anode battery cell, FIGS. 22A and B show the results of a charge C-rate cycling test at 25° C. In FIGS. 22A and B, “CC Region” denotes the constant current charge region before reaching the constant voltage charge region. The test shows a stable trend for all the C/3, C/2, 1 C, 2 C, 3 C and 3.5 C CC region charge capacity. The 3.5 C-rate CC region charge capacity retention to the first three cycles of the C/3 CC charge is about 56%. FIG. 23 shows various charge C-rate curves at 25° C. All the charge C/3, C/2, 1 C, 2 C, 3 C and 3.5 C rate curves show a stable trend. FIG. 24 shows that, in a 3.5 C-rate fast charge under CCCV at 25° C., 80% state of charge (SOC) can be achieved in about 15 min of charging even with an electrode having a high loading ≥5.8 mAh/cm². The figures show that the battery cell exhibits great charge/discharge rate capabilities.

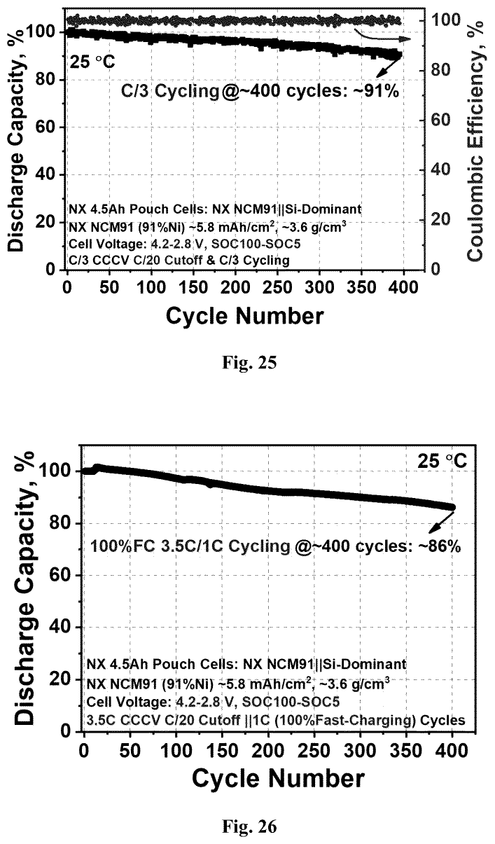

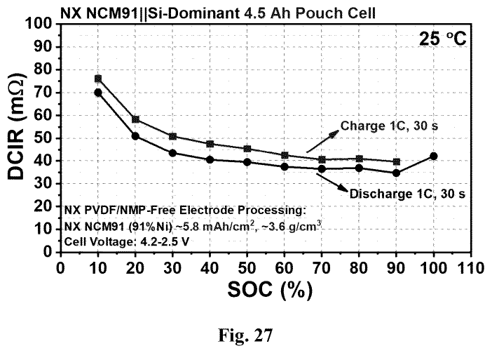

Relating to the cycle life of the NCM91 cathode/silicon-dominant anode battery cell, FIG. 25 shows that, under C/3 cycling in the range of 4.2-2.8 V (100% SOC −5% SOC) at 25° C., the battery cell achieves 400 cycles with about 91% discharge capacity retention. FIG. 26 shows that, under 100% fast charging via 3.5 C/1 C cycling in the range of 4.2-2.8 V (100% SOC −5% SOC) at 25° C., the battery cell achieves 400 cycles with about 86% discharge capacity retention. FIG. 27 shows the hybrid power pulse characterization (HPPC) direct current internal resistance (DCIR) over a range of state of charge (SOC) at 25° C. The battery cell has a low HPPC DCIR at 50% SOC of about 39 mΩ. The DCIR may be a proxy for equivalent series resistance (ESR).

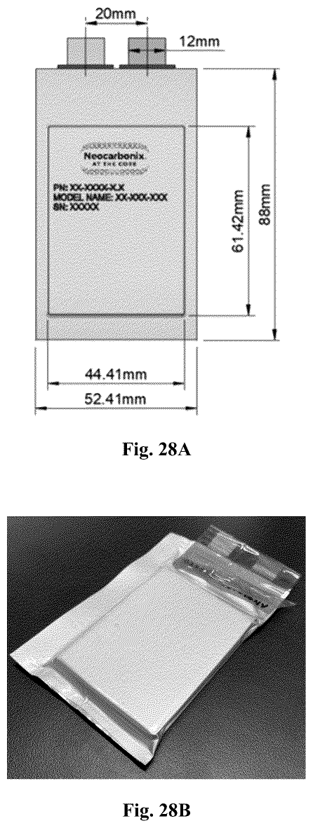

Table 2 lists physical parameters for an embodiment of the NCM91 cathode/silicon-dominant anode battery cell in the form of a pouch cell. As evident from Table 2, the pouch cell is compact and light. FIG. 28A shows dimensions of the pouch cell, and FIG. 28B shows the outside of the pouch cell. Considering the excellent electrochemical performance and properties, compactness and lightness of the pouch cell, the pouch cells can be stacked into layers to form modules that make up a lithium-ion battery for electric vehicles.

TABLE 2

| | | |
|---|---|---|
| Core X Dimension | 44.4 | mm |
| Core Y Dimension | 61.4 | mm |
| Core Thickness | 6.4 | mm |
| Core Volume | 17.5 | mL |
| Total Volume (including pouch | 17.9 | mL |
| dimensions, edges and thickness) | | |
| Measured Weight | 48.7 | g |

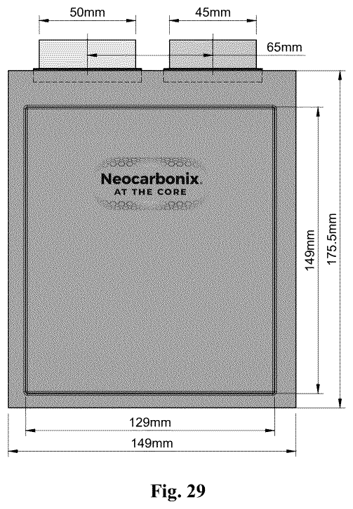

In other embodiments, a battery cell comprises a PVDF-free/NMP-free, nickel-rich NMC cathode having similar components and composition as described above for the NCM91 cathode/silicon-dominant anode battery cell except that a different nickel-rich NMC may be used. Nickel-rich NMCs are described above. The active layer of the anode comprises about 30-40% (e.g., about 40%) of a silicon/graphite composite material, about 51.5% graphite, about 1.5% nanocarbon(s) (e.g., carbon nanotubes), and about 7% polymer(s) by weight/mass. The battery cell comprises a separator and an electrolyte similar to the separator and the electrolyte of the NCM91 cathode/silicon-dominant anode battery cell. The battery cell can contain, e.g., 27 anodes and 28 cathodes. The battery cell has a capacity of about 50 Ah and an energy density of about 350 Wh/kg. An embodiment of the battery cell in the form of a pouch has dimensions as shown in FIG. 29, a thickness of 7.7 mm and a weight of 0.515 kg. The pouch cell can be used to form a lithium-ion battery for electric vehicles.

Battery cells comprising PVDF-free/NMP-free electrodes (e.g., cathodes) can also contain other cathode materials or/and other anode materials. For example, the cathode, such as the active layer of the cathode, can comprise manganese, NMC (whether or not nickel-rich, such as NMC622, NMC721 or MMC811), NCA (whether or not nickel-rich, such as NCA90), LCO, LFP, or a solid-state catholyte. Material that the anode, such as the active layer of the anode, can comprise include without limitation silicon (whether or not silicon-dominant), micro-silicone, silicon oxide, a silicon composite material (e.g., a silicon/carbon composite such as a silicon/graphite composite), or graphite, or any combination thereof. As a non-limiting example, a battery cell can comprise a lithium iron phosphate (LFP) cathode and a silicon-dominant anode and can be designed to have a loading ≥about 4.5 mAh/cm², capacity≥about 60 Ah, a gravimetric energy density in the range of about 220-240 Wh/kg, and a volumetric energy density in the range of about 540-560 Wh/L for use in electric vehicles.

The battery cells can be any battery type. For example, the battery can be a lithium-ion battery comprising a PVDF-free/NMP-free cathode, an anode containing graphite or/and silicon (whether or not silicon-dominant), and a liquid electrolyte. As another example, the battery can be a solid-state battery (e.g., a solid-state lithium-ion battery) comprising a PVDF-free/NMP-free cathode, a lithium metal anode or a silicon-dominant anode, and a solid electrolyte. Lithium and silicon can store more energy in less volume and mass than graphite. The solid electrolyte can comprise, e.g., polymer(s) or/and ceramic(s) and can also function as a separator. A solid electrolyte is typically non-flammable, while a liquid electrolyte may contain flammable organic solvent(s). As a further example, the battery can be an anode-less battery comprising a PVDF-free/NMP-free cathode or catholyte, a current collector (e.g., a metal foil such as a copper foil), and a solid or liquid electrolyte. A solid-state, anode-less battery comprises a solid electrolyte or a catholyte. A catholyte combines cathode materials and a solid electrolyte to form a single layer. Each of the battery type can comprise a plurality of the cathode and a plurality of the anode, optionally different numbers of the cathode and the anode. The process for making a cathode (e.g., a PVDF-free/NMP-free cathode) for lithium-ion batteries is similar to the process for making a cathode for solid-state batteries or a cathode or catholyte for anode-less batteries.

The battery cells can be used in variety of applications. For example, the battery cells can be used to form batteries (e.g., lithium-ion batteries) for use in electric vehicles, laptop computers, tablets, smartphones and other mobile devices, and electric appliances.

The battery cells can have any suitable form depending on their intended application. For example, the battery cells can have a cylindrical form or a prismatic form, or can be in the form of a pouch, a flat pack or a coin.

### Example 5. Manufacturing of Electrodes

Cathodes, including PVDF-free/NMP-free cathodes, and anodes can be fabricated according to the methods disclosed in US 2023/0238509 A1, which is incorporated herein by reference in its entirety. In some embodiments, a method for fabricating an electrode for an energy storage device (e.g., a battery or an ultracapacitor) comprises:
heating a mixture of solvent(s) and material(s) for use as energy storage media;
adding active material to the mixture;
adding a dispersant to the mixture to provide a slurry;
coating a current collector with the slurry; and
calendering the coating of slurry on the current collector to provide the electrode.

In some embodiments, the method further comprises partially or fully drying the coated current collector, such as by subjecting the coated current collector to heat or/and vacuum, prior to calendering the partially or fully dried, coated current collector.

In some embodiments, the method further comprises sintering the coating of slurry on the current collector.

In some embodiments, the energy storage material(s) comprise nanocarbon(s), such as carbon nanotubes. In some embodiments, the active material comprises a metal oxide (e.g., a lithium metal oxide such as an NMC) or LFP for a cathode active layer. In further embodiments, the active material comprises silicon, a silicon composite material (e.g., silicon/graphite), silicon oxide or graphite, or any combination thereof, for an anode active layer.

Solvent(s) that can be used to form the mixture include without limitation an alcohol (e.g., methanol, ethanol or isopropyl alcohol), acetonitrile, tetrahydrofuran, de-ionized water, and any combinations thereof. Use of solvent(s) having a low boiling point facilitates drying of the electrode active layer. In certain embodiments, the solvent for fabrication of a cathode (e.g., an NMC cathode) is or comprises ethanol. In other embodiments, the solvent for fabrication of an LFP cathode is or comprises de-ionized water. In some embodiments, the solvents for fabrication of an anode (e.g., a silicon-dominant anode) are or comprise water and ethanol (e.g., ≤about 10% ethanol by weight or volume). The solvent(s) do not include toxic and difficult-to-recycle NMP, which renders the manufacturing process more environmentally friendly, greatly increases throughput, and reduces cost and energy consumption.

A dispersant generally acts as an emulsifier and disintegrant (of, e.g., solution polymerization), and nay also act as a surfactant and shape-controlling agent in nanoparticle formation and self-assembly. Examples of a dispersant include without limitation polyvinylpyrrolidone (PVP, a water-soluble polymer), polyacrylic acid, sodium polyacrylate, and AQUACHARGE (a tradename for an aqueous binder for electrodes, sold by Sumitomo Seika Chemicals Co., Ltd. of Hyogo, Japan).

Polymer additive(s), polymer(s) or surfactant(s) can also be added to the mixture, such as in the step of dispersant addition, to enhance adhesion of the materials within the active layer to each other and adhesion between the active layer and the current collector. The polymer additive(s) or polymer(s) do not include PVDF.

Alternative to coating a current collector with the final slurry, the final slurry may be formed into a sheet and then coated directly onto the current collector or onto an intermediate layer such as an optional adhesion layer on the current collector.

Other aspects of the electrode fabrication method are described in detail in the section with the heading “Fabrication Methods”.

While the invention has been described with reference to exemplary embodiments, it will be understood that various changes may be made and equivalents may be substituted for elements thereof without departing from the scope of the invention. For example, in some embodiments, one of the foregoing layers may include a plurality of layers therein. In addition, modifications in adapting a particular device, component or material to the present disclosure can be made without departing from the essential scope thereof. Therefore, the invention is not limited to the particular embodiments and examples disclosed herein, but rather the invention includes all variations, modifications and equivalents thereof and all embodiments falling within the scope of the appended claims.

What is claimed is:

1. An energy storage device comprising an electrode comprising:
an active layer comprising an active material and a nanocarbon, wherein the active layer is substantially free of polyvinylidene fluoride/difluoride (PVDF) and N-methyl-2-pyrrolidone (NMP); and
a current collector.

2. The energy storage device of claim 1, wherein the nanocarbon has a high aspect ratio.

3. The energy storage device of claim 1, wherein the nanocarbon is selected from the group consisting of carbon nanotubes, graphene, oxidized graphene, exfoliated graphite nano-platelets, carbon nanoparticles, carbon powder, activated carbon, carbon black, carbon nanofibers, carbon nanohorns, carbon nano-onions, fullerene, carbon aerogels, and combinations thereof.

4. The energy storage device of claim 3, wherein the nanocarbon comprises carbon nanotubes.

5. The energy storage device of claim 1, wherein the nanocarbon has a surface treatment which enhances adhesion of the nanocarbon to the active material and adhesion of the active layer to the current collector.

6. The energy storage device of claim 1, wherein the active layer further comprises a polymer additive, a polymer or a surfactant, or any combination thereof.

7. The energy storage device of claim 1, wherein the electrode is a cathode, and the active material comprises lithium iron phosphate, a lithium cobalt oxide, a lithium manganese oxide, a lithium nickel manganese oxide, a lithium nickel manganese cobalt oxide, a lithium nickel cobalt aluminum oxide or a lithium titanate oxide.

8. The energy storage device of claim 7, wherein the active material comprises a nickel-rich lithium nickel manganese cobalt oxide.

9. The energy storage device of claim 8, wherein the active layer of the cathode comprises by weight about 90-99% of a nickel-rich lithium nickel manganese cobalt oxide; about 0.5-5% of the nanocarbon; and about 0.5-5% of a polymer additive, a polymer or a surfactant, or any combination thereof.

10. The energy storage device of claim 1, wherein the electrode is a cathode, and the current collector comprises an aluminum foil.

11. The energy storage device of claim 1, wherein the electrode is an anode, and the active material comprises silicon, a silicon oxide, a silicon composite material or graphite, or any combination thereof.

12. The energy storage device of claim 11, wherein the active material comprises silicon as the dominant element by weight.

13. The energy storage device of claim 12, wherein the active layer of the anode comprises by weight about 60-90% of silicon or/and a silicon composite material; about 5-20% of graphite; about 1-5% of the nanocarbon; and about 5-20% of a polymer additive, a polymer or a surfactant, or any combination thereof.

14. The energy storage device of claim 1, wherein the electrode is an anode, and the current collector comprises a copper foil.

15. The energy storage device of claim 1, further comprising an electrolyte comprising one or more lithium salts and one or more carbonate solvents.

16. The energy storage device of claim 15, wherein the electrolyte comprises LiPF₆ or/and lithium bis(fluorosulfonyl)imide (LiFSI), and one or more linear carbonate solvents.

17. The energy storage device of claim 15, wherein the electrolyte further comprises one or more additives.

18. The energy storage device of claim 17, wherein the one or more additives comprise one or more cyclic carbonates.

19. The energy storage device of claim 1, which:
(a) has a specific energy of at least about 330 Wh/kg;
(b) has a gravimetric energy density of at least about 330 Wh/kg;
(c) has a volumetric energy density of at least about 850 Wh/L;
(d) has a capacity of at least about 50 Ah;
(e) has an internal resistance of no more than about 40 mΩ;
(f) charges to 80% stage of charge within about 15 minutes;
(g) has an operating voltage range of at least about 4.0-2.5 V; or
(h) has a cycle life of at least about 750 charge/discharge cycles; or
(i) any combination or all of the above.

20. The energy storage device of claim 1, which is a battery cell or a battery.
